(19) United States
(12) Patent Application Publication
(10) Pub. No.: US 2026/0350211 A1
(43) Pub. Date: Nov. 5, 2026

(54) METHODS AND APPARATUS FOR CREATING, TRANSFERRING, REVISING, AND VERIFYING PROMISSORY FILES

(71) Applicant: Knova Finance Corp., Dover, DE (US)

(72) Inventors: Jason Klein, Seabrook, TX (US); Jeremiah Goyette, Austin, TX (US); Francis Kim, Toronto (CA); Ryan Michael Tate, Tacoma, WA (US)

(73) Assignee: Knova Finance Corp., Dover, DE (US)

(21) Appl. No.: 19/213,681

(22) Filed: May 20, 2025

Related U.S. Application Data
(63) Continuation-in-part of application No. 18/082,630, filed on Dec. 16, 2022, now Pat. No. 12,307,442.
(60) Provisional application No. 63/290,133, filed on Dec. 16, 2021.

(51) Int. Cl. G06F 21/62; H04L 9/08; H04L 9/30; H04L 9/32

(52) U.S. Cl. CPC G06F 21/6245; H04L 9/0825; H04L 9/30; H04L 9/3236; H04L 9/3247

(57) ABSTRACT

Provided are methods and apparatus for issuing, authorizing, sending, receiving, verifying and reporting cryptographic promissory files. Collectively, these methods and apparatus enable implementation of a secure, concurrent, and high-volume cryptographic digital money and asset infrastructure for reserve monetary, commercial monetary, digital, and Real-World Asset transactions.

### CROSS-REFERENCE TO RELATED APPLICATIONS

This application claims priority to and is a continuation-in-part of U.S. Non-Provisional patent application Ser. No. 18/082,630, filed on Dec. 16, 2022, which claims the benefit of U.S. Provisional Patent Application No. 63/290,133, filed on Dec. 16, 2021, the entireties of which are hereby incorporated by reference herein.

### FIELD OF DISCLOSURE

This disclosure generally relates to digital financial asset systems, electronics, computer-readable media, computer engineering, and more specifically, but not exclusively, to methods and apparatus for recording and transferring ownership of fixed-value bearer instruments using asymmetric cryptography.

### BACKGROUND

Paper bearer instruments, such as banknotes, are transacted among independent entities, often in private settings without a central or shared account ledger maintaining a balance for each entity, allowing transactions between independent entities to be negotiated and settled concurrently, and directly between peers.

Centralized account-based systems introduce a need for a third party to decrement and increment the balance of accounts negotiating a settlement, while also enabling anti-fraud mechanisms for restricting transfers and preventing illicit activities, which in contrast paper bearer instruments do not inherently provide.

Accordingly, it can be understood that both systems offer benefits to economic networks;

however, existing solutions fall short of providing the high-volume concurrency of fixed-value bearer instruments combined with the monitoring and capital controls provided in a federated account-based system.

Accordingly, there are previously unaddressed and long-felt industry needs for methods and apparatus that improve upon conventional methods and conventional apparatus.

### SUMMARY

In examples, provided is a scalable solution that demonstrates concurrent, high-volume transactions, while introducing asymmetric cryptographic guarantees against fraudulent activities that can be used to provide oversight and control in a reserve and commercial system. The provided methods and apparatus address the previously unaddressed and long-felt industry needs for methods and apparatus that improve upon the conventional methods and the conventional apparatus.

Existing account-based financial systems face several challenges for enabling a concurrent, high-volume digital infrastructure for reserve transactions, commercial transactions, monetary transactions, asset transactions, and combinations thereof.

Concurrency in an account-based system requires the database to be divided into logical shards. However, concurrency is not guaranteed among databases, since two operations can be performed in two different logical shards for a single transaction, and therefore both database shards must hold a mutually exclusive lock on the underlying data to perform the operation in sync.

In account-based systems, concurrency is only enabled for optimistic settlements where operations are between accounts in the same logical shard. To guarantee atomicity, consistency, isolation and durability (ACID) properties for account records, additional checks are introduced to manage state changes between accounts, hindering high-volume performance.

An account-based system must increment and decrement account entries in the system for multiple accounts when performing a transaction. Additionally, an account-based system must implement complex batch processing algorithms for enabling concurrent, high-volume transactions.

An account-based transaction batch processing algorithm requires determining existing account balance state in the logical database shards and determining whether the result of the batch process will result in insufficient funds for one or more accounts. Additionally, an account-based system must be able to apply or roll-back account balance state changes, which requires a mutually exclusive lock on the database shard(s), adding to performance bottlenecks in the processing of transactions.

In comparison, the disclosed methods and apparatus can logically shard the ownership record of value on the cryptographic promissory file itself. Furthermore, the disclosed methods and apparatus can demonstrate authorized signing of promissory file(s) can be batched for verification and signing, which can be processed in parallel due the logical shard of value ownership being represented in the promissory file record itself. Batch processing of promissory file(s) for authorized signing requires that the promissory file is read from record and is cryptographically checked against the current and historical owners of the incoming promissory file. The record stored by the notary, an entity that is approved and signed by the authority, is the promissory file itself, and the latest verified copy is updated and replicated in persistent storage.

By removing the need to calculate complex multi-account balance increments and decrements in the batch processing of transfers, the disclosed methods and apparatus can enable the system to perform concurrent, high-volume transactions that otherwise pose difficult, scalability challenges for account-based systems.

The disclosed methods and apparatus can enable performance scalability and fault tolerances through the ability for the notary service to provide an authorized cryptographic signature for a promissory file. In practice, this means that the process of cryptographically signing a transaction can be delegated to thousands of different service processes, reducing bottleneck performance issues in account-based systems or services with only one accepted cryptographic signer.

An account-based transaction system must enable secure login to the remote account. As a result, logging into a financial institution account can encounter offline errors, inaccessibility, or denial of service (Dos) attacks. If an account-based system is unavailable, client account balances can be unavailable as well as the ability to transact.

In comparison, the disclosed methods and apparatus can provide the ability to transfer promissory file ownership directly between two participants, without requiring a third party or account-based system to perform the transfer. Cryptographically signing the promissory file is a local operation that does not require logging into a remote financial institution account to perform a transaction.

As asset authorities explore new digital manifestations of assets, it is critical that the systems implemented maintain a level of transactional oversight and control for ensuring the safety and validity of the economic network.

Paper bearer instruments, such as banknotes, offer concurrent, high-volume properties. However, banknotes are difficult to sanction due to their ability to be transacted in private settings, without the need for a third party to be involved.

In comparison, the disclosed methods and apparatus can introduce the ability for promissory file(s) to be transacted directly between participants in private settings, while maintaining the record of ownership on the promissory file itself, which is later processed by the notary service.

Additionally, the disclosed methods and apparatus can discuss the purpose of the authorization signature to be used, in one embodiment, to restrict the transferring of promissory file(s), which is achieved simply by withholding an authorized signature. This feature can be used in cases where fraudulent or criminal activity is detected.

The disclosed methods and apparatus can provide anti-fraud mechanisms that are often features of an account-based systems, while maintaining peer-to-peer cash-like properties. In addition, the disclosed methods and apparatus can include a timestamp in each of the signature blocks of a promissory file, enabling reporting systems to determine when a particular owner held the promissory file.

Unspent Transaction Output (UTXO) based systems, such as Bitcoin, require an entire amount of an asset to be locked, held, unavailable, or a combination thereof during a transaction confirmation, which can take substantial amount of time (for example, 10-60 minutes). For examples, when a sender has 1000 units and needs to send one unit, the other 999 units in change is not available until confirmation is complete, thus locking liquidity and impacting business scalability.

In comparison, the disclosed methods and apparatus can provide a ‘change’ promissory file back immediately, allowing the sender to transact the ‘change’ amount freely without having the ‘change’ amount locked up.

Collectively, these systems, methods, and schema enable implementation of a secure, concurrent and high-volume cryptographic digital asset infrastructure for reserve and commercial transactions that are superior in transactional scalability compared to account-based systems.

As is described in greater detail herein, the instant disclosure describes various methods and apparatus for generating at least a portion of a machine configured to automatically construct a new promissory file. The provided methods and apparatus address the previously unaddressed and long-felt industry needs for methods and apparatus that improve upon the conventional methods and the conventional apparatus.

In an example, provided is a computer-implemented method for constructing a new promissory file that is cryptographically signable, verifiable, and represents an asset issued by an asset authority. The method can include (i) creating, using the computing device, the new promissory file, where the new promissory file comprises information describing: a universally unique identifier; a version number; a cryptographic signature system; a decimal amount; an asset code; a cryptographic public key matching a cryptographic signing key; a cryptographic public key of the asset owner; a cryptographic public key of the asset authority; a promissory file issuance date timestamp that is generated by an operating system; a cryptographic signature by the notary of a latest promissory file hash; a cryptographic signature by the previous promissory file owner of a latest promissory file hash; a notary that authorizes a transfer, including information describing the notary cryptographic public key and a signature of the notary cryptographic public key from the asset authority; a list of asset provenance, comprising an identifier of a previous promissory file, a respective cryptographic hash of the previous promissory file, and a respective decimal amount deducted from a previous promissory file to add to the value of the new promissory file; and a commitment group configured to link the new promissory file to the transaction identifier, commitment identifiers between involved parties, and a group name; (ii) creating, using the computing device and based on information stored in the new promissory note, an initial hash of the new promissory file, wherein the initial hash is signed by the cryptographic signing key of the asset authority and the notary; (iii) storing, using the computing device, the initial hash in the new promissory file; and (iv) storing, using the computing device, the new promissory file in a file system.

In an example, the method can further include (i) reading, using the computing device, the new promissory file; and (ii) returning values stored in the new promissory file.

In an example, the method can further include (i) calculating, using the computing device, a next promissory file hash by creating a new hash digest of the new promissory file and a cryptographic public key of an intended recipient to transfer ownership of the new promissory file to the intended recipient; and (ii) cryptographically signing the new promissory file by: (a) the asset authority after the new promissory file is created and prior to an initial transfer of ownership; or (b) a previous owner of the new promissory file when the new promissory file is subsequently transferred; and (iii) cryptographically signing the new promissory file by the notary of the new hash digest.

In an example, the method can further include (i) searching, using the computing device, a file system directory for instances of previous promissory files to create a list of previous promissory files; and (ii) returning, from read file buffers, information in the list of previous promissory files.

In an example, the method can further include saving, in the file system, a file name for a promissory file instance based on (i) a character string representation of the asset code; (ii) the decimal amount; and (iii) the universally unique identifier.

In an example, the method can further include issuing, using the computing device, the new promissory file.

In an example, the method can further include ordering, using the computing device, comparison promissory files, where the ordering is based on decimal normalized amounts of the comparison promissory files.

In an example, the method can further include normalizing, using the computing device, a promissory file instance amount against promissory files having different decimal place precisions.

In an example, the method can further include (i) calculating, using the computing device, an immediate previous hash of an immediate previous promissory file; and (ii) returning the immediate previous hash of the immediate previous promissory file.

In an example, the method can further include retrieving, from the file system, latest ownership details of the new promissory file.

In an example, the method can further include (i) an identifier of the immediate previous promissory file; (ii) an asset value of the immediate previous promissory file; (iii) a hash of the immediate previous promissory file; or (iv) a combination thereof.

In an example, the method can further include (i) receiving a cryptographic public key of a recipient; (ii) assigning, using the computing device, ownership of the new promissory file by (a) using a cryptographic public key of the recipient to calculate a next promissory file hash; and (b) cryptographically signing the next promissory file hash with a cryptographic signing key of a current promissory file owner; (iii) supplying, using the computing device, a cryptographic signature and a cryptographic public address of the recipient for use in a cryptographic verification and construction of a next promissory file hash; (iv) updating, using the computing device, a state of the new promissory file; and (v) returning latest promissory data in the new promissory file.

In an example, the method can further include using the computing device, a cryptographic signature from a notary of a calculated next promissory file hash for use in cryptographic verification and construction of a next promissory file hash.

In an example, the method can further include (i) maintaining network connectivity to the notary, wherein the notary retains a copy of previous promissory files; and (ii) communicating, with the notary, as a portion of a transfer of the new promissory file, only the immediate previous promissory file identifier, the initial hash, and the respective decimal amount deducted from a previous promissory file to add to the value of the new promissory file.

In an example, the method can further include, where a plurality of parties are exchanging digital promissory files, ensuring, by the notary, that either all transfers of the digital promissory files in the exchange complete or none of the transfers of the digital promissory files in the exchange complete.

In an example, the method can further include (i) verifying, using the computing device, a cryptographic correctness of the promissory file solely from information stored in the promissory file; (ii) computing, using the computing device, a provenance promissory file hash; (iii) recursing, using the computing device, a list of asset provenance files; (iv) verifying, using the computing device, notary and previous owner cryptographic signatures for a latest promissory file hash and from a list of provenance promissory files; and (v) verifying correctness of the promissory file without reliance on network connectivity.

In an example, the method can further include (i) receiving, using the computing device and from the asset authority, an asynchronous cryptographic signature of the promissory file that is: (a) a signature for a current promissory file hash or; (b) a signature for pre-authorizing a next computed promissory file hash based on a cryptographic public key of a recipient; and (ii) updating, using the computing device, an authorized signature of the promissory file.

In an example, the method can further include (i) organizing, using the computing device, a plurality of promissory files for a given cryptographic public key in a binary heap to sort from highest to lowest respective decimal normalized promissory file amounts; and (ii) calculating, using the computing device, a nearest balance of an account to a parameterized asset amount from a sorted collection.

In examples, provided is a system configured to automatically construct a new promissory file that is cryptographically signable, verifiable, and represents an asset issued by an asset authority, comprising: (i) an electronic processor configured to execute a set of computer-executable instructions; and (ii) a memory communicatively coupled to the electronic processor and storing the set of computer-executable instructions, where the set of computer-executable instructions are configured to cause the electronic processor to: (a) create the new promissory file, where the new promissory file comprises information describing: (I) a universally unique identifier; (II) a version number; (III) a cryptographic signature system; (IV) a decimal amount; (V) a cryptographic public key matching a cryptographic signing key; (VI) a cryptographic public key of the asset owner; (VII) a cryptographic public key of the asset authority; (VIII) a promissory file issuance date timestamp that is generated by an operating system; (IX) a cryptographic signature by the notary of a latest promissory file hash; (X) a cryptographic signature by the previous promissory file owner of a latest promissory file hash; (XI) a list of asset provenance, comprising an identifier of a previous promissory file, a respective cryptographic hash of the previous promissory file, and a respective decimal amount deducted from a previous promissory file to add to the value of the new promissory file; and (XII) a commitment group configured to link the new promissory file to the transaction identifier, commitment identifiers between involved parties, and (XIII) a group name; (b) create, based on information stored in the new promissory note, an initial hash of the new promissory file, wherein the initial hash is signed by the cryptographic signing key of the asset authority and the notary; (c) store the initial hash in the new promissory file; and (d) store the new promissory file in a file system.

In an example, the memory can further store instructions configured to cause the processor to (i) read the new promissory file; and (ii) return values stored in the new promissory file.

In an example, the memory can further store instructions configured to cause the processor to: (i) calculate a next promissory file hash by creating a new hash digest of the new promissory file and a cryptographic public key of an intended recipient to transfer ownership of the new promissory file to the intended recipient; and (ii) cryptographically sign the new promissory file by: (a) the asset authority after the new promissory file is created and prior to an initial transfer of ownership; or (b) a previous owner of the new promissory file when the new promissory file is subsequently transferred; and (iii) cryptographically signing the new promissory file by the notary of the new hash digest.

In an example, the memory can further store instructions configured to cause the processor to (i) search a file system directory for instances of previous promissory files to create a list of previous promissory files; and (ii) return, from read file buffers, information in the list of previous promissory files.

In an example, the memory can further store instructions configured to cause the processor to save, in the file system, a file name for a promissory file instance based on (i) a character string representation of the asset code; (ii) the decimal amount; and (iii) the universally unique identifier.

In an example, the memory can further store instructions configured to cause the processor to issue the new promissory file.

In an example, the memory can further store instructions configured to cause the processor to order comparison promissory files, wherein the ordering is based on decimal normalized amounts of the comparison promissory files.

In an example, the memory can further store instructions configured to cause the processor to normalize a promissory file instance amount against promissory files having different decimal place precisions.

In an example, the memory can further store instructions configured to cause the processor to (i) calculate an immediate previous hash of an immediate previous promissory file; and (ii) return the immediate previous hash of the immediate previous promissory file.

In an example, the memory can further store instructions configured to cause the processor to retrieve, from the file system, latest ownership details of the new promissory file.

In an example, the memory can further store instructions configured to cause the processor to retrieve, from the file system (i) an identifier of the immediate previous promissory file; (ii) an asset value of the immediate previous promissory file; (iii) a hash of the immediate previous promissory file; or (iv) a combination thereof.

In an example, the memory can further store instructions configured to cause the processor to (i) receive a cryptographic public key of a recipient; (ii) assign ownership of the new promissory file by (a) using a cryptographic public key of the recipient to calculate a next promissory file hash; and (b) cryptographically signing the next promissory file hash with a cryptographic signing key of a current promissory file owner; (iii) supply a cryptographic signature and a cryptographic public address of the recipient for use in a cryptographic verification and construction of a next promissory file hash; (iv) update a state of the new promissory file; and (v) return latest promissory data in the new promissory file.

In an example, the memory can further store instructions configured to cause the processor to supply a cryptographic signature from a notary of a calculated next promissory file hash for use in cryptographic verification and construction of a next promissory file hash.

In an example, the memory can further store instructions configured to cause the processor to (i) maintain network connectivity to the notary, wherein the notary retains a copy of previous promissory files; and (ii) communicate, with the notary, as a portion of a transfer of the new promissory file, only the immediate previous promissory file identifier, the initial hash, and the respective decimal amount deducted from a previous promissory file to add to the value of the new promissory file.

In an example, the memory can further store instructions configured to cause the processor to ensure, by the notary when a plurality of parties are exchanging digital promissory files, that either all transfers of the digital promissory files in the exchange complete or none of the transfers of the digital promissory files in the exchange complete.

In an example, the memory can further store instructions configured to cause the processor to (i) verify a cryptographic correctness of the promissory file solely from information stored in the promissory file; (ii) compute, using the computing device, a provenance promissory file hash; (iii) recurse, using the computing device, a list of asset provenance files; (iv) verify notary and previous owner cryptographic signatures for a latest promissory file hash and from a list of provenance promissory files; and (v) verify correctness of the promissory file without reliance on network connectivity.

In an example, the memory can further store instructions configured to cause the processor to (i) receive, from the asset authority, an asynchronous cryptographic signature of the promissory file that is (a) a signature for a current promissory file hash or; (b) a signature for pre-authorizing a next computed promissory file hash based on a cryptographic public key of a recipient; and (ii) update an authorized signature of the promissory file.

In an example, the memory can further store instructions configured to cause the processor to (i) organize a plurality of promissory files for a given cryptographic public key in a binary heap to sort from highest to lowest respective decimal normalized promissory file amounts; and (ii) calculate a nearest balance of an account to a parameterized asset amount from a sorted collection.

Embodiments of the disclosed methods and apparatus are directed to processes and techniques, including at least partially automated processes and at least partially automated techniques, to perform at least a portion of a feature described herein. In some embodiments, the disclosed systems include computer architecture components that can provide interfaces, code snippets, data structures, and information relationships to enable performing at least a portion of a feature described herein.

In an embodiment, the disclosure is directed to an apparatus configured to perform at least a portion of a feature described herein. The apparatus can include a non-transitory computer-readable medium storing a set of computer-executable instructions and an electronic processor or co-processors. When executed by the electronic processor or co-processors, the instructions cause the electronic processor or co-processors (or a device of which they are part) to perform a set of operations that implement an embodiment of the disclosed methods.

In an example, provided is a non-transitory computer-readable medium, comprising processor-executable instructions stored thereon configured to cause a processor to (i) create a new promissory file, where the new promissory file comprises information describing (a) a universally unique identifier; (b) a version number; (c) a cryptographic signature system; (d) a decimal amount; (e) a cryptographic public key matching a cryptographic signing key; (f) a cryptographic public key of the asset owner; (g) a cryptographic public key of the asset authority; (h) a promissory file issuance date timestamp that is generated by an operating system; (i) a cryptographic signature by the notary of a latest promissory file hash; (j) a cryptographic signature by the previous promissory file owner of a latest promissory file hash; (k) a notary that authorizes a transfer, including information describing the notary cryptographic public key and a signature of the notary cryptographic public key from the asset authority; (l) a list of asset provenance, comprising an identifier of a previous promissory file, a respective cryptographic hash of the previous promissory file, and a respective decimal amount deducted from a previous promissory file to add to the value of the new promissory file; and (m) a commitment group configured to link the new promissory file to the transaction identifier, commitment identifiers between involved parties, and (n) a group name; (ii) create, based on information stored in the new promissory note, an initial hash of the new promissory file, wherein the initial hash is signed by the cryptographic signing key of the asset authority and the notary; (iii) store the initial hash in the new promissory file; and (iv) store the new promissory file in a file system.

In an example, the non-transitory computer-readable medium can further include processor-executable instructions stored thereon configured to cause the processor to (i) read the new promissory file; and (ii) return values stored in the new promissory file.

In an example, the non-transitory computer-readable medium can further include processor-executable instructions stored thereon configured to cause the processor to (i) calculate a next promissory file hash by creating a new hash digest of the new promissory file and a cryptographic public key of an intended recipient to transfer ownership of the new promissory file to the intended recipient; and (ii) cryptographically sign the new promissory file by (a) the asset authority after the new promissory file is created and prior to an initial transfer of ownership; or (b) a previous owner of the new promissory file when the new promissory file is subsequently transferred; and (iii) cryptographically signing the new promissory file by the notary of the new hash digest.

In an example, the non-transitory computer-readable medium can further include processor-executable instructions stored thereon configured to cause the processor to (i) search a file system directory for instances of previous promissory files to create a list of previous promissory files; and (ii) return, from read file buffers, information in the list of previous promissory files.

In an example, the non-transitory computer-readable medium can further include processor-executable instructions stored thereon configured to cause the processor to save, in the file system, a file name for a promissory file instance based on (i) a character string representation of the asset code; (ii) the decimal amount; and (iii) the universally unique identifier.

In an example, the non-transitory computer-readable medium can further include processor-executable instructions stored thereon configured to cause the processor to issue the new promissory file.

In an example, the non-transitory computer-readable medium can further include processor-executable instructions stored thereon configured to cause the processor to order comparison promissory files, wherein the ordering is based on decimal normalized amounts of the comparison promissory files.

In an example, the non-transitory computer-readable medium can further include processor-executable instructions stored thereon configured to cause the processor to normalize a promissory file instance amount against promissory files having different decimal place precisions.

In an example, the non-transitory computer-readable medium can further include processor-executable instructions stored thereon configured to cause the processor to (i) calculate an immediate previous hash of an immediate previous promissory file; and (ii) return the immediate previous hash of the immediate previous promissory file.

In an example, the non-transitory computer-readable medium can further include processor-executable instructions stored thereon configured to cause the processor to retrieve, from the file system, latest ownership details of the new promissory file.

In an example, the non-transitory computer-readable medium can further include processor-executable instructions stored thereon configured to cause the processor to retrieve, from the file system (i) an identifier of the immediate previous promissory file; (ii) an asset value of the immediate previous promissory file; (iii) a hash of the immediate previous promissory file; or (iv) a combination thereof.

In an example, the non-transitory computer-readable medium can further include processor-executable instructions stored thereon configured to cause the processor to (i) receive a cryptographic public key of a recipient; (ii) assign ownership of the new promissory file by using a cryptographic public key of the recipient to calculate a next promissory file hash; and cryptographically signing the next promissory file hash with a cryptographic signing key of a current promissory file owner; (iii) supply a cryptographic signature and a cryptographic public address of the recipient for use in a cryptographic verification and construction of a next promissory file hash; (iv) update a state of the new promissory file; and (v) return latest promissory data in the new promissory file.

In an example, the non-transitory computer-readable medium can further include processor-executable instructions stored thereon configured to cause the processor to supply a cryptographic signature from a notary of a calculated next promissory file hash for use in cryptographic verification and construction of a next promissory file hash.

In an example, the non-transitory computer-readable medium can further include processor-executable instructions stored thereon configured to cause the processor to (i) maintain network connectivity to the notary, wherein the notary retains a copy of previous promissory files; and (ii) communicate, with the notary, as a portion of a transfer of the new promissory file, only the immediate previous promissory file identifier, the initial hash, and the respective decimal amount deducted from a previous promissory file to add to the value of the new promissory file.

In an example, the non-transitory computer-readable medium can further include processor-executable instructions stored thereon configured to cause the processor to ensure, by the notary when a plurality of parties are exchanging digital promissory files, that either all transfers of the digital promissory files in the exchange complete or none of the transfers of the digital promissory files in the exchange complete.

In an example, the non-transitory computer-readable medium can further include processor-executable instructions stored thereon configured to cause the processor to (i) verify a cryptographic correctness of the promissory file solely from information stored in the promissory file; (ii) compute, using the computing device, a provenance promissory file hash; (iii) recurse, using the computing device, a list of asset provenance files; (iv) verify notary and previous owner cryptographic signatures for a latest promissory file hash and from a list of provenance promissory files; and (v) verify correctness of the promissory file without reliance on network connectivity.

In an example, the non-transitory computer-readable medium can further include processor-executable instructions stored thereon configured to cause the processor to (i) receive, from the asset authority, an asynchronous cryptographic signature of the promissory file that is (a) a signature for a current promissory file hash or; (b) a signature for pre-authorizing a next computed promissory file hash based on a cryptographic public key of a recipient; and (ii) update an authorized signature of the promissory file.

In an example, the non-transitory computer-readable medium can further include processor-executable instructions stored thereon configured to cause the processor to (i) organize a plurality of promissory files for a given cryptographic public key in a binary heap to sort from highest to lowest respective decimal normalized promissory file amounts; and (ii) calculate a nearest balance of an account to a parameterized asset amount from a sorted collection.

In an example, provided is a computer-implemented method for auditing a promissory file history. The method can include (i) receiving, at a computing device configured to check a history of a digital promissory file and a related list of provenance promissory files, the digital promissory file, the history of the digital promissory file, and the related list of provenance promissory files; and (ii) reviewing, recursively and using the computing device, the history of the digital promissory file and the related list of provenance promissory files to verify that amounts of the digital promissory file and the provenance promissory files and information in the digital promissory file were correctly calculated.

In examples, provided is a system configured to audit a promissory file history, comprising (i) an electronic processor configured to execute a set of computer-executable instructions; and (ii) a memory communicatively coupled to the electronic processor and storing the set of computer-executable instructions, where the set of computer-executable instructions are configured to cause the electronic processor to (a) receive, at a computing device configured to check a history of a digital promissory file and a related list of provenance promissory files, the digital promissory file, the history of the digital promissory file, and the related list of provenance promissory files; and (b) review, recursively, the history of the digital promissory file and the related list of provenance promissory files to verify that amounts of the digital promissory file and the provenance promissory files and information in the digital promissory file were correctly calculated.

In an example, provided is a non-transitory computer-readable medium, comprising processor-executable instructions stored thereon configured to cause a processor to (i) receive, at a computing device configured to check a history of a digital promissory file and a related list of provenance promissory files, the digital promissory file, the history of the digital promissory file, and the related list of provenance promissory files; and (ii) reviewing, recursively and using the computing device, the history of the digital promissory file and the related list of provenance promissory files to verify that amounts of the digital promissory file and the provenance promissory files and information in the digital promissory file were correctly calculated.

In an example, provided is a computer-implemented method for transferring digital promissory files. The method can include (i) creating, using a computing device, a change promissory file to a transferor, wherein an amount of the change promissory file equals a difference in amounts of promissory files being transferred; (ii) transferring the change promissory file to the transferor; and (iii) creating, upon a successful transfer, a transfer promissory file representing an amount to be sent to a transferee.

In an example, the method can further include combining respective amounts from multiple promissory files into the transfer promissory file, the change promissory file, the refund promissory file, or a combination thereof.

In an example, the method can further include (i) creating, upon the successful transfer, a refund promissory file; and (ii) retaining, by the computing device, the refund promissory file.

In an example, the computing device can be configured to perform a notary service on a digital promissory file.

In examples, provided is a system configured to transfer digital promissory files, comprising (i) an electronic processor configured to execute a set of computer-executable instructions; and (ii) a memory communicatively coupled to the electronic processor and storing the set of computer-executable instructions, where the set of computer-executable instructions are configured to cause the electronic processor to: (i) creating, using a computing device, a change promissory file to a transferor, wherein an amount of the change promissory file equals a difference in amounts of promissory files being transferred; (ii) transferring the change promissory file to the transferor; and (iii) creating, upon a successful transfer, a transfer promissory file representing an amount to be sent to a transferee.

In an example, the memory can further store instructions configured to cause the processor to combine respective amounts from multiple promissory files into the transfer promissory file, the change promissory file, the refund promissory file, or a combination thereof.

In an example, the memory can further store instructions configured to cause the processor to (i) create, upon the successful transfer, a refund promissory file; and (ii) retain, by the computing device, the refund promissory file.

In examples, the system can be configured to perform a notary service on a digital promissory file.

In an example, provided is a non-transitory computer-readable medium, comprising processor-executable instructions stored thereon configured to cause a processor to (i) create, using a computing device, a change promissory file to a transferor, wherein an amount of the change promissory file equals a difference in amounts of promissory files being transferred; (ii) transfer the change promissory file to the transferor; and (iii) create, upon a successful transfer, a transfer promissory file representing an amount to be sent to a transferee.

In an example, the non-transitory computer-readable medium can further include processor-executable instructions stored thereon configured to cause the processor to combine respective amounts from multiple promissory files into the transfer promissory file, the change promissory file, the refund promissory file, or a combination thereof.

In an example, the non-transitory computer-readable medium can further include processor-executable instructions stored thereon configured to cause the processor to (i) create, upon the successful transfer, a refund promissory file; and (ii) retain, by the computing device, the refund promissory file.

In an example, the non-transitory computer-readable medium can further include processor-executable instructions stored thereon configured to cause the processor to perform a notary service on a digital promissory file.

In an example, provided is a computer-implemented method for transferring digital promissory files. The method can include (i) receiving, at a computing device, an instruction to transfer a digital promissory file; and (ii) creating, upon an unsuccessful transfer of the digital promissory file, a refund promissory file representing an amount to be sent to a transferor.

In examples, provided is a system configured to transferring digital promissory files, comprising (i) an electronic processor configured to execute a set of computer-executable instructions; and (ii) a memory communicatively coupled to the electronic processor and storing the set of computer-executable instructions, where the set of computer-executable instructions are configured to cause the electronic processor to (a) receive an instruction to transfer a digital promissory file; and (b) create, upon an unsuccessful transfer of the digital promissory file, a refund promissory file representing an amount to be sent to a transferor.

In an example, provided is a non-transitory computer-readable medium, comprising processor-executable instructions stored thereon configured to cause a processor to (i) receive, at a computing device, an instruction to transfer a digital promissory file; and (ii) create, upon an unsuccessful transfer of the digital promissory file, a refund promissory file representing an amount to be sent to a transferor.

In some embodiments, the methods and apparatus disclosed herein can provide services through a software as a service (Saas), a multi-tenant platform, or a combination thereof. The multi-tenant platform can provide access to multiple entities (e.g. tenants), each with a separate account and associated data storage. Each account can correspond to a User, set of Users, an entity, a set or category of entities, a company, a business advisor, a set or category of Users, an industry, an organization, or a combination thereof, as examples. Each account can access one or more services, a set of which are instantiated in their account, and which implement at least a portion of one or more of the methods or functions disclosed herein.

The terms “invention,” “the invention,” “this invention,” “the present invention,” “the present disclosure,” or “the disclosure” as used herein are intended to refer broadly to all subject matter disclosed in this document, the drawings (i.e. the Figures), and the claims. Statements containing these terms do not limit the subject matter disclosed or the meaning or scope of the claims. Embodiments covered by this disclosure are defined by the claims and not by this summary. This summary is a high-level overview of various examples and aspects of the disclosure and introduces some concepts that are further described in detail hereby. This summary is not intended to identify key, essential, or required features of the claimed subject matter, nor is it intended to be used in isolation to determine the scope of the claimed subject matter. The subject matter should be understood by reference to appropriate portions of the entire specification, to any or all figures or drawings, and to each claim.

Advantages of the provided systems, apparatuses, and methods will be apparent to one of ordinary skill in the art upon review of the detailed description and the included Figures. While the exemplary embodiments provided hereby are susceptible to various modifications and alternative forms, specific embodiments are shown by way of example in the drawings and are described in detail herein. However, the exemplary or specific embodiments are not intended to be limited to the forms described. Rather, the disclosure covers all modifications, equivalents, and alternatives falling within the scope of the appended claims.

### BRIEF DESCRIPTION OF THE DRAWINGS

Embodiments are illustrated by way of example, and not by way of limitation, in the figures of the accompanying drawings and in which like reference numerals refer to similar elements.

Embodiments of the disclosure are described with reference to the drawings, in which:

FIG. 1A depicts an exemplary class diagram of a cryptographic promissory file instance in accordance with embodiments of the disclosed methods and apparatus.

FIG. 1B depicts an exemplary activity diagram describing a cryptographic promissory file verification process in accordance with embodiments of the disclosed methods and apparatus.

FIG. 1C depicts an exemplary deployment diagram of a cryptographic promissory file demonstrating the stack depth compiler constraints of the recursive signature block linked-list hash chain in accordance with embodiments of the disclosed methods and apparatus.

FIG. 2A and FIG. 2B depict exemplary activity diagrams illustrating a monetary authority service and a delegated currency issuer service establishing currency issuance limits and registers its public key with the authority service in accordance with embodiments of the disclosed methods and apparatus.

FIG. 2C depicts an exemplary flow chart illustrating the process and systems for issuing cryptographic promissory files in accordance with embodiments of the disclosed methods and apparatus.

FIG. 3 depicts an exemplary sequence diagram illustrating the interactions between a remote device, a delegated currency issuer service, a sanctions service, and an authority service to distribute cryptographic promissory files in accordance with embodiments of the disclosed methods and apparatus.

FIG. 4 depicts a sequence diagram of a peer-to-peer cryptographic promissory file transaction between remote devices and an authority service, demonstrating the ability for the file to be sent between two peers without the presence of an authorized signature from the monetary authority service in accordance with embodiments of the disclosed methods and apparatus.

FIG. 5 depicts an exemplary sequence diagram illustrating systems for pre-authorizing of peer-to-peer transactions of promissory files in accordance with embodiments of the disclosed methods and apparatus.

FIG. 6A depicts an exemplary sequence diagram illustrating systems for remitting promissory files in accordance with embodiments of the disclosed methods and apparatus.

FIG. 6B depicts an exemplary sequence diagram illustrating systems for foreign currency exchange of promissory files in accordance with embodiments of the disclosed methods and apparatus.

FIG. 7 depicts a flow chart for a foreign exchange service that conducts a transaction involving the exchange of cryptographic promissory files in accordance with embodiments of the pre disclosed methods and apparatus.

FIG. 8 depicts a sequence diagram illustrating custodian service serving as a storage for cryptographic promissory files, using public key identities to authenticate and claim ownership of cryptographic promissory files in accordance with embodiments of the disclosed methods and apparatus.

FIG. 9 illustrates a deployment diagram of systems for processing cryptographic promissory files, including several services and remote devices with interfaces for receiving and sending cryptographic promissory files in accordance with embodiments of the disclosed methods and apparatus.

FIG. 10 illustrates the replication of cryptographic promissory files amongst authority services and delegated currency issuer services in accordance with embodiments of the disclosed methods and apparatus.

FIGS. 11A-11C depict an exemplary class diagram of a cryptographic promissory file instance in accordance with embodiments of the disclosed methods and apparatus.

FIG. 12 depicts an example flowchart of method where a sender transfers one or more promissory files and a process in which a transfer promissory file, the change promissory file, the refund promissory file, or a combination thereof is created and remitted to a sender, receiver, or both depending on amounts owed in accordance with embodiments of the disclosed methods and apparatus.

FIG. 13 depicts a lifecycle of a promissory file state when transferring ownership to having the promissory file authorized by a notary in accordance with embodiments of the disclosed methods and apparatus.

FIG. 14 depicts a non-limiting example method for constructing a new promissory file that is cryptographically signable, verifiable, and represents an asset issued by an asset authority, in accordance with an embodiment of the disclosure.

FIG. 15A depicts an example network implementation of a system suitable for implementing examples of the disclosed subject matter.

FIG. 15B depicts an example diagram of an example computing device suitable for implementing examples of the disclosed subject matter.

Each of the drawings is provided for illustration and description only and does not limit the present disclosure. In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method.

### DETAILED DESCRIPTION

Defined embodiments are discussed in detail with reference to the accompanying figures. Identical elements in the presented figures are denoted by like reference numerals for consistency. The following description of embodiments contain several defined details provided for improving the understanding of the disclosed methods and apparatus. The provided descriptions of the embodiments shall be understood to not limit the disclosure of these embodiments. To the contrary, the disclosures are provided to cover alternatives, modifications and equivalents, which are included in the essence and scope of the disclosure by the appended claims. It will be apparent to one of ordinary skill in the art that the disclosed methods and apparatus can be practiced independent of the defined details. It will be understood that obvious features are not described to avoid unnecessarily complicating the description.

In examples, the best mode of the disclosed methods and apparatus can involve using an efficient and broadly supported serialization and deserialization format for cryptographic promissory files. An ideal format can ensures cryptographic promissory files are implemented in a lightweight wire format for transmission over networking protocols, e.g., Transmission Control Protocol (TCP), User Datagram Protocol (UDP), etc. Embodiments of the disclosed methods and apparatus can be implemented in various serialization formats that permit recursion.

In examples, the disclosed methods and apparatus can be network layer agnostic. Systems for processing cryptographic promissory files best communicate using a bi-directional, event-driven architecture. Cryptographic promissory files can be used in connection with other networking protocols to enable efficient relaying, routing and packet switching amongst connected peers.

In examples, the disclosed methods and apparatus can involve systems whose methods are best carried out as remote procedural calls (RPCs). Ideally, systems are implemented as “micro-services” to be modular, composable and scalable to make benefit the parallel and concurrent processing capabilities of cryptographic promissory files.

In examples, provided are systems, methods and schema for issuing, authorizing, sending, receiving, verifying and reporting cryptographic promissory files (“CPFs”). In one embodiment, a cryptographic promissory file schema is disclosed. The cryptographic promissory file schema can compromise: a data structure for representing the semantic version number of the promissory file schema, a cryptographic signature system used, a universally unique identifier for a promissory file, an asset code, an amount, an authority cryptographic public key, an owner cryptographic public key, an issuance date timestamp, an authorized signature of the promissory file hash signed by the notary, a secured signature of the hash, signed by the previous owner public key or the authority public key for the first creation of the promissory file, a notary that authorizes each transfer, including the notary cryptographic public key and the signature of it from the asset authority, a list of asset provenance, comprised of identifiers of previous one or more promissory file(s), respective cryptographic hash(es) of the previous one or more promissory file(s), and respective decimal amount(s) deducted from the previous one or more promissory file(s) to add to the value of the current promissory file, a commitment group, linking the promissory file to transaction identifiers, commitments identifiers between involved parties, and group names.

In examples, the promissory file can be instantiated in various file formats (e.g., flatbuffers, protocol buffers, JSON, XML, etc.), and files can be communicated over agnostic Open Systems Interconnection (OSI) transport, network and dataframe layers (e.g., Internet Protocol, NFC, Bluetooth, LoRa, NB-IoT, SigFox, etc.). In examples, additional fields can be added to the promissory file, which might include an interest rate and maturity date to represent a debt instrument that accrues interest, or a semantic version number to identify versions of the promissory file, or bit flag to denote the type of instrument the promissory file represents or a bit flag to denote the type of asymmetric cryptographic algorithms used for signing and verifying the promissory file.

The cryptographic promissory file schema, along with methods and procedures for verifying authenticity and ownership, enable systems, in one or more embodiments of the disclosed methods and apparatus, to provide a secure, concurrent and high-volume cryptographic digital asset infrastructure for reserve and commercial transactions.

Embodiments of the disclosed methods and apparatus can relate to computer and mobile device systems which can include one or more of the following methods of the cryptographic promissory file schema, used individually or collectively with other methods listed: methods for issuing, authorizing, sending, receiving, verifying and reporting cryptographic promissory files.

In general, in one aspect, embodiments of the disclosed methods and apparatus can relate to a computer processing system for issuing cryptographic promissory files, which can include software instructions for: (i) providing an Internet Protocol (IP) network accessed application programming interface (API) for remote devices to request transferring of promissory files, (ii) requesting and maintaining issuance limits from an authority service, (iii) constructing new promissory files, (iv) cryptographically signing promissory files, (v) requesting an authorized signature from a notary service, (vi) recording issued promissory files in a persistent writable and readable storage, (vii) verifying promissory files, (viii) screening a sanctions list for denying transferring of promissory file ownership, (ix) requesting an encrypted know-your-customer (KYC) digital identity relationship associated with cryptographic public keys, and (x) maintaining a persistent writable and readable storage of promissory files.

In general, in one aspect, embodiments of the disclosed methods and apparatus can relate to a computer processing system for authorizing promissory files, which can include software instructions for: (i) providing an Internet Protocol (IP) network accessed application programming interface (API) for remote devices to request an authorized signature of promissory files, (ii) approving issuance limits to authorized delegated issuers, (iii) maintaining a record of ownership of promissory files in persistent writable and readable storage, (iv) maintaining issuance limits for authorized issuers in a persistent writable and readable storage, (v) verifying promissory files, (vi) identifying double spends or “forks” from the observability of duplicate owners of a promissory file at a specific point, (vii) reporting double spends or fraudulent activities to prosecuting authorities, (viii) screening a sanctions list for denying authorization of promissory file ownership, (ix) requesting an encrypted know-your-customer (KYC) digital identity relationship associated with cryptographic public keys, (x) maintaining a persistent writable and readable storage of promissory files, and (xi) destroying or archiving issued promissory files on behalf of an authorized issuer.

In general, in one aspect, embodiments of the disclosed methods and apparatus can relate to a computer processing system for exchanging promissory files across various asset types, which can include software instructions for: (i) providing an Internet Protocol (IP) network accessed application programming interface (API) for remote devices to request the foreign currency or asset exchange of promissory files, (ii) maintaining an order book of promissory files to be exchanged for promissory files in a foreign currency or asset, (iii) receiving delegation of promissory files for the atomic transfer of promissory files, (iv) cryptographically signing promissory files for the transferring of ownership, (v) responding to request for quotes (RFQs) for currency or asset pair exchange rates, (vi) reporting settlements of exchanged promissory files, (vii) remitting payments of foreign currency or asset promissory files to a forwarding address represented by an Internet Protocol (IP) network address, email address, crypto wallet address or other Open Systems Interconnection (OSI) transport layer address, (viii) searching sanctions screening lists for sending and receiving parties involved in the exchange of promissory files, (ix) reporting incidents of sanctioned or fraudulent activities to authorities, and (x) requesting an authorized signature from a notary for the new owner of the transferred promissory file.

In general, in one aspect, embodiments of the disclosed methods and apparatus can relate to a computer processing system for remitting promissory files, which can include software instructions for: (i) providing an Internet Protocol (IP) network accessed application programming interface (API) for remote devices to request the remittance of promissory files to a forwarding address represented by an Internet Protocol (IP) network address, email address or other Open Systems Interconnection (OSI) transport layer address, (ii) receiving delegation of promissory files for the atomic transfer of promissory files, (iii) cryptographically signing promissory files for the transferring of ownership to the remitted party, (iv) reporting settlements of exchanged promissory files, (v) searching sanctions screening lists for sending and receiving parties involved in the remittance of promissory files, (vi) reporting incidents of sanctioned or fraudulent activities to authorities, and (vii) requesting an authorized signature from a notary for the new owner of the transferred promissory file.

In general, in one aspect, embodiments of the disclosed methods and apparatus can relate to a computer processing system for sanctions screening promissory files, which can include software instructions for: (i) compiling consolidated sanctions lists authored by authorities and intergovernmental organizations (IGOs), (ii) comparing personal identifiable information (PII) against the compiled sanctions list, (iii) providing an Internet Protocol (IP) network accessed application programming interface (API) for remote devices to request the screening of promissory file ownership based on cryptographic public keys associated with personal identifiable information (PII) against the consolidated sanctions list, (iv) matching personal identifiable information (PII) against a consolidated sanctions list based on a matching algorithm, (v) maintaining an indexed record of cryptographic public keys associated with sanctioned entities, and (vi) reporting sanctioned entities associated with cryptographic public keys to authorities.

In general, in one aspect, embodiments of the disclosed methods and apparatus can relate to a computer processing system for maintaining custodianship of promissory files, which can include software instructions for: (i) providing an Internet Protocol (IP) network accessed application programming interface (API) for remote devices to request the storage of promissory files on behalf of a cryptographic public key representing ownership of the promissory files, and (ii) retrieving promissory files held by the custodian service using proof of ownership based on cryptographic signature of request parameters and the public key for which the cryptographic signature matches.

In general, in one aspect, embodiments of the disclosed methods and apparatus can relate to a computer processing system for point-of-sale terminals transacting promissory files, which can include software instructions for: (i) maintaining a cryptographic key pair to sign and prove ownership of promissory files, (ii) providing a cryptographic public key identifier using a QR code or other means to request promissory files from a customer, (iii) calculating residual amounts owed back to customers when receiving an excess amount of promissory files, (iv) transferring promissory files that represent change back to the customer, and (v) exchanging promissory files for change of promissory files with a notary service.

In one or more embodiments, the cryptographic promissory file can be self-describing and can be directly verifiable based on the cryptographic signatures and asset provenance list stored within. The structure and properties of the promissory file enable it to be read and written without a central, account-based service. In examples, the file can be stored on personal computer (PC), mobile devices and other embedded environments, such as NFC chips.

Embodiments of the disclosed methods and apparatus enable promissory files to be transferred directly to another peer, without a third party or central service performing the transfer. Albeit the new owner of the promissory file must receive an authorized signature at a future time before being allowed to transfer the file to another peer. In examples, these properties enable promissory files to be transacted concurrently without connected dependencies and performance bottlenecks that arise in account-based systems.

In general, in one aspect, embodiments of the disclosed methods and apparatus can relate to a computer processing system for validating known promissory files at a point in time. Promissory files can maintain an ownership record within asset provenance list of the immediate previous promissory files, and given a promissory file, the notary is able to recursively go back in history for all previous assets and a list of provenance promissory files of the promissory file, and validate all amounts have been correctly calculated. The notary service can record all known promissory files for which the notary service has given an authorized signature, but the promissory file holder can only maintain a record of promissory file(s) of the promissory file holder and immediate previous promissory files thereof.

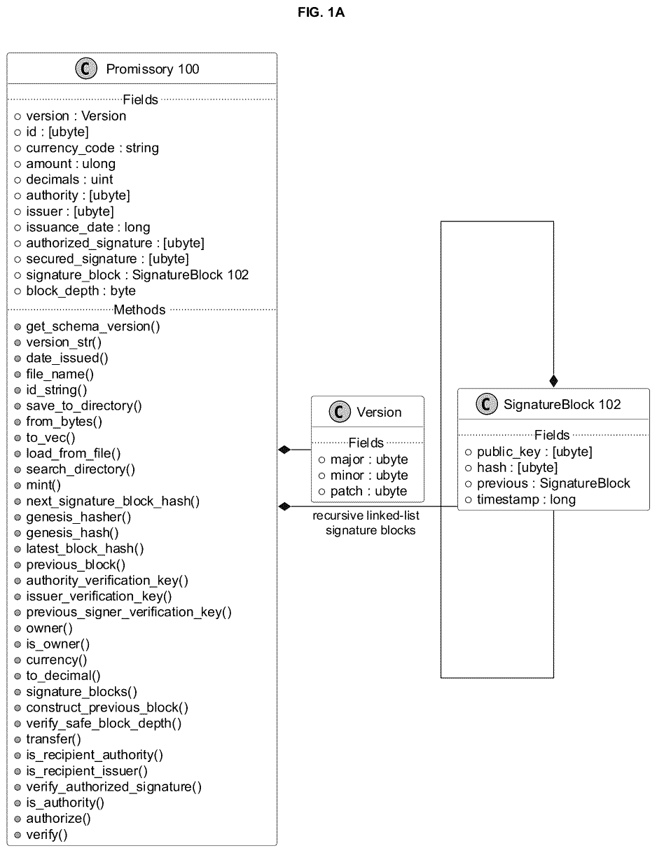

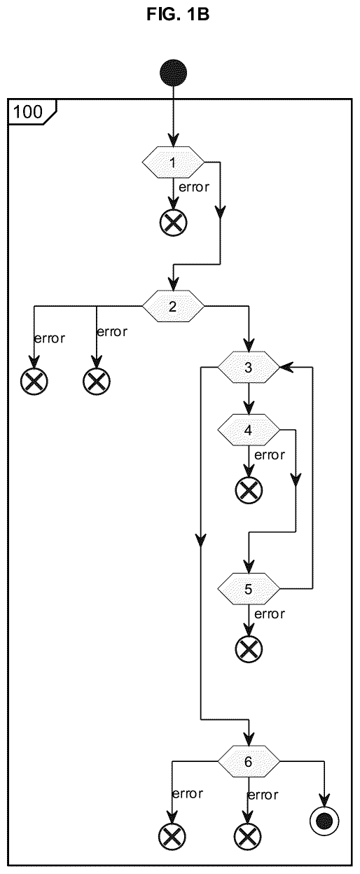

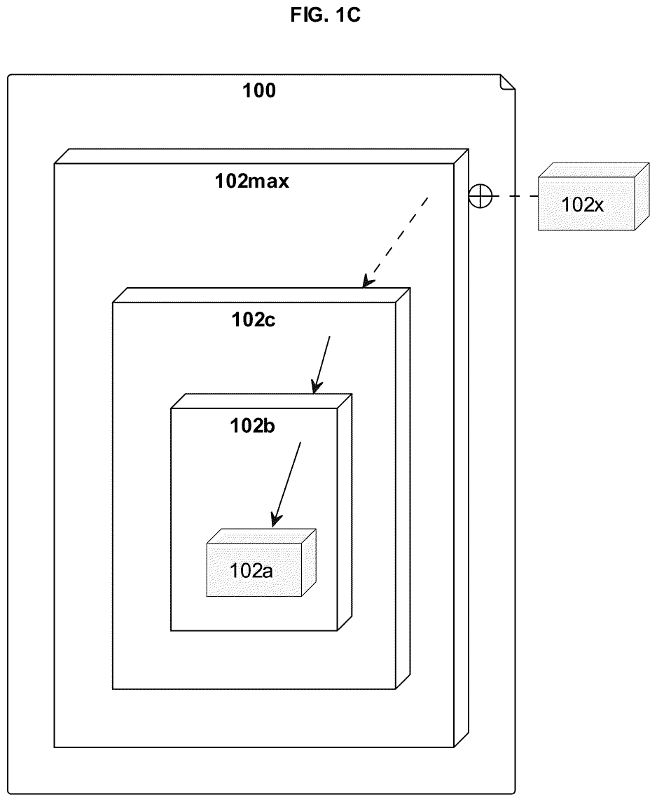

We now turn to FIG. 1A.

FIG. 1A depicts a class diagram of an instance of a cryptographic promissory file 100, including its fields and associative methods. In one or more embodiments, the promissory file 100 methods comprise: getter methods for returning stored values of the promissory file, methods for recursing the signature block linked-list hash chain 102 and calculating a block depth byte 104 according the number of signature blocks in the linked-list, a method for calculating the next signature block hash, a method for verifying 103 the correctness of the promissory file, a method for transferring ownership of the promissory file, a method for minting a new promissory file, methods for serializing and deserializing the promissory file to and from a byte array, methods for reading a promissory file from a local or remote directory, methods for saving a file to a local or remote directory, methods for searching for promissory files located in a local or remote directory. In examples, additional fields and methods can be implemented for the promissory file. The cryptographic promissory file is reference number 100 in the figures and descriptions. Methods and properties of cryptographic promissory files 100 are referenced in the 1XX series numbers in figures and descriptions.

We now turn to FIG. 1B.

FIG. 1B depicts an activity diagram describing the cryptographic promissory file 100 verification process 103 which can be executed on a general computing system (e.g., mainframe, Linux container, virtualized computer, personal computer or other general computing device) with or without Internet connectivity. FIG. 1B step 1 is to load and deserialize the cryptographic promissory file 100 from stored binary code. Verification process 103 will error if deserialization of cryptographic promissory file 100 fails. FIG. 1B step 2 checks the authority 200 and delegated currency issuer 300 public key identities of the cryptographic promissory file 100 compared against known public key identities. If either of those identities do not match known identities for the public keys stored in the promissory file 100, then cryptographic promissory file is invalid and will result in an error. Additionally, FIG. 1B step 2 illustrates that if a root signature block 102 does not exist for a cryptographic promissory file 100 the file is invalid and will result in an error. FIG. 1B step 3 illustrates a while loop to recurse the signature block linked-list hash chain 102 until the root or genesis signature block is found. FIG. 1B step 4 calculates the current hash of the most recent signature block 102 from the prior signature blocks 102 n. FIG. 1 B step 5 illustrates that if the number of signature blocks 102 does not equal the block depth of the promissory file 100, then the verification process will result in an error. FIG. 1B step 6 performs two checks; first to ensure the secured signature matches current signature block 102 hash for the public key found in the previous signature block 102 to verify that the prior owner has assigned a new owner; and second, to ensure the authorized signature for the current signature block 102 hash matches either the authority or delegated currency issuer public key. Importantly, if only the secured signature is valid and the authorized signature is not present, then the cryptographic promissory file 100 is “pending authorization” and cannot be further transferred or assigned to a new owner until a valid authorized signature is provided in the cryptographic promissory file 100. The requirement of both the secured signature and the authorized signature acts as a two-phase lock on the cryptographic promissory file 100, where the first phase is a local, preparatory process to record the secured signature from the current owner for the transfer of the cryptographic promissory file 100 to a new owner recorded a new signature block 102 with the new owner's public key. Without the authorization signature from the authority or delegated currency issuer of the cryptographic promissory file 100, the file is locked in a “pending authorization” state and cannot be transferred to a new owner. The second phase of the cryptographic promissory file 100 is to obtain the authorized signature for the latest signature block 102 in the file. Only after verifying the validity of both the secured signature and the authorized signature is the cryptographic promissory file 100 authorized and can be assigned to a new owner. In one or more embodiments of the disclosed methods and apparatus, cryptographic promissory files 100 enable a concurrent, high-volume cryptographic digital asset infrastructure for reserve and commercial transactions.

We now turn to FIG. 1C.

FIG. 1C illustrates cryptographic promissory file 100 and its recursive signature block linked-list hash chain 102 describing a predicate in which its max block depth 104 is reached, denying an additional signature block 102 from being committed to cryptographic promissory file 100. The purpose of the signature block 102 max block depth 104 is to limit cryptographic promissory files 100 from growing in perpetuity. Using a recursive signature block structure 102 lends itself to enforcing compiler stack depth constraints on the number of signature blocks 102 that can be added to cryptographic promissory file 100. Once cryptographic promissory file 100 reaches its max block depth 104 limit, no further signature blocks can be permitted for cryptographic promissory file 100 to be transferred. Effectively, cryptographic promissory file 100 has reached its finite life and must be archived for reporting. Another cryptographic promissory file 100 can be issued to replace the retired cryptographic promissory file 100. In one embodiment of the disclosed methods and apparatus, the stack depth limit of the recursive signature block linked-list hash chain 102 provides guarantees against the non-reporting of cryptographic promissory files 100 amongst replicated authority services 200 and delegated currency issuer services 300.

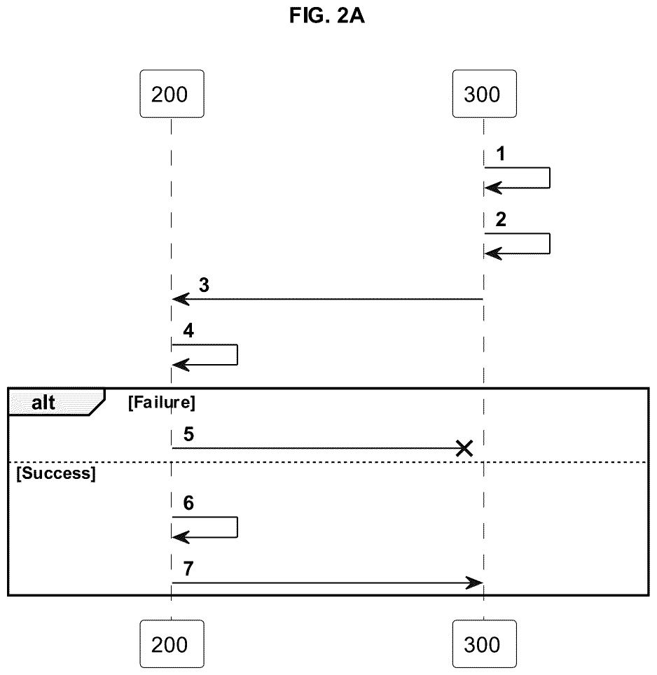

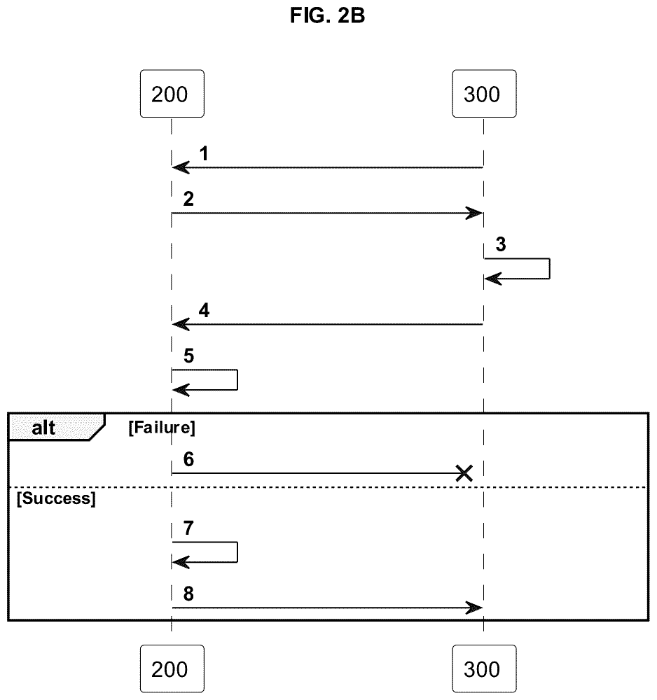

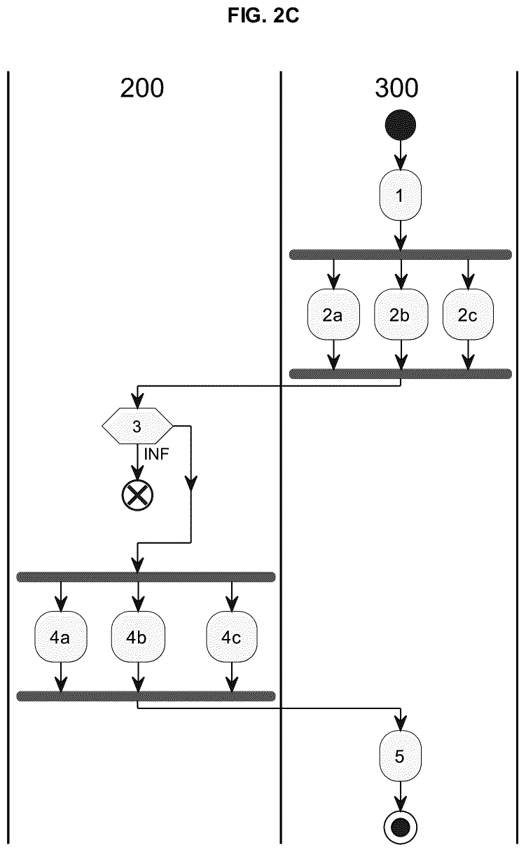

We now turn to FIGS. 2A-2B.

FIG. 2A and FIG. 2B illustrate a monetary authority service 200 and a delegated currency issuer service 300. Services 200 and 300 can be executed on a general computing system (e.g., mainframe, Linux container, virtualized computer, personal computer or other general computing device) located on premise or remotely, accessible using an Internet Protocol (IP) address.

As illustrated in FIG. 2A step 1, delegated currency issuer service 300 initializes a cryptographic key pair used to register service 300 with an authority service 200.

FIG. 2A step 2 indicates that delegated currency issuer service 300 cryptographic signs a message containing its public key identity using its asymmetric private key corresponding to the public key identity.

FIG. 2A step 3 indicates service 300 registering its public key with authority service 200.

FIG. 2A step 4 indicates authority service 200 checking to ensure the cryptographic signature of delegated currency issuer service 300 matches its public key identity, demonstrates ownership of the private key.

FIG. 2A step 5 is an alternative response if the check if the previous step fails, in which delegated currency issuer service 300 will receive an invalid request response.

FIG. 2A step 6 indicates authority service 200 records delegated currency issuer services 300 public key identity, establishes currency issuance limits corresponding to delegated currency issuer service 300 and records the current issued cryptographic promissory file(s) 100 amounts for each delegated currency issuer service 300. In examples, the currency issuance limits, and public key identities can be recorded in a database or other persistent storage system.

FIG. 2A step 7 depicts authority service 200 responding with an available cryptographic promissory file 100 issuance limit to delegated currency issuer service 300. Once delegated currency issuer service 300 has established its currency limit with the authority service 200, delegated currency issuer service 300 can issue cryptographic promissory file(s) 100 up to the total issuance limit available to the delegated currency issuer service 300.

We now turn to FIG. 2B.

FIG. 2B step 1 illustrates delegated currency issuer service 300 requesting the public key identity from authority service 200.

FIG. 2B step 2 illustrates authority service 200 responding with its public key identity to delegated currency issuer service 300.

FIG. 2B step 3 illustrates delegated currency issuer service 300 using the public key identity of authority service 200 and its own public key identity to establish the authority and the issuer public key identities in each cryptographic promissory file 100. FIG. 2B step 3 further illustrates delegated currency issuer 200 using its private key created in FIG. 2A step 1 to cryptographically sign the root signature block 102 hash of each cryptographic promissory file 100, and store the signature as the secured signature within the file. Cryptographic promissory file(s) 100 are not valid until authority service 200 provides an authorized signature for each file 100 matching the public key for the authority set in the file.

FIG. 2B step 4 depicts delegated currency issuer service 300 sending cryptographic promissory file(s) 100 to authority service 200 for authorization.

FIG. 2B step 5 depicts authority service 200 validating the cryptographic signature of delegated currency issuer service 300 for each cryptographic promissory file 100.

FIG. 2B step 6 demonstrates a failure of authority service 200 to validate cryptographic promissory file(s) 100 based on the verification method 103 described in FIG. 1B.

FIG. 2B step 7 illustrates authority service 200 providing an authorized signature for each cryptographic promissory file 100 and reducing the available issuance limit for delegated currency issuer service 300 based on the denominated value of each cryptographic promissory file(s) 100.

FIG. 2B step 8 depicts authority service 200 responding to delegated currency issuer service 300 with the fully signed and authorized cryptographic promissory file(s) 100. Service 300 can be represented as a commercial bank or other financial institution that is involved in the issuance and distribution of promissory file(s) 100. In examples, the cryptographic signing keys for services 200 and 300 can be stored in an ancillary service, such as a hardware security module (HSM). In one or more embodiments of the disclosed methods and apparatus, services 200 and 300 enable a concurrent, high-volume cryptographic digital asset infrastructure for reserve and commercial transactions.

We now turn to FIG. 2C.

FIG. 2C illustrates the parallel processing of issuing and authorizing cryptographic promissory files 100 by delegated currency issuer service 300 and authority service 200.

FIG. 2C step 1 describes delegated currency issuer service 300 preparing a batch of cryptographic promissory files 100 to be issued.

FIG. 2C steps 2a, 2b and 2c describe the parallel processing of cryptographically signing the root signature block 102 in each cryptographic promissory file 100 within a batch.

FIG. 2C step 3 depicts authority service 200 debiting the issuance limit of delegated currency issuer service 200, checking for insufficient funds if the net batch amount of cryptographic promissory files 100 exceeds the issuance limit of delegated currency issuer service 200.

FIG. 2C steps 4a, 4b and 4c describe the parallel processing of authority service 200 for cryptographically signing the signature block 102 of each cryptographic promissory file 100 to provide an authorized signature.

FIG. 2C step 5 describes the return of the fully authorized and issued cryptographic promissory files 100 from authority service 200 to delegated currency issuer service 300.

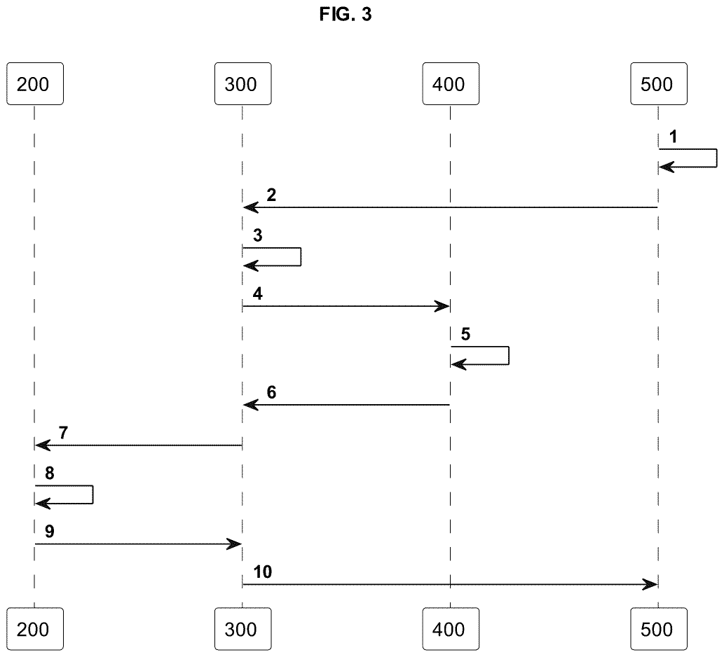

We now turn to FIG. 3.

FIG. 3 illustrates the interactions of a remote device 500 (e.g., mobile phone, personal computer, laptop, tablet, etc.), a delegated currency issuer service 300, a sanctions service 400, and an authority service 200 demonstrating an exemplary process for distributing cryptographic promissory file(s) 100.

FIG. 3 step 1 demonstrates remote device 500 initializing a cryptographic key pair used to identify the remote device and to cryptographically sign promissory file(s) 100.

FIG. 3 step 2 depicts remote device 500 requesting funds from the delegated currency issuer service 300, providing its public key and personally identifiable information (PII), if not previously available. In examples, remote device 500 can request promissory file(s) 100 through a loan or other mechanism for distributing funds.

FIG. 3 steps 3 through 5 demonstrates delegated currency issuer service 300 sending remote device 500 user PII to sanctions service 400 to assert remote device 500 is permitted to hold and transact cryptographic promissory file(s) 100.

FIG. 3 step 6 depicts delegated currency issuer 300 transferring ownership of cryptographic promissory file(s) 100 by creating a new signature block with the public key of remote device 500, providing a secured signature for each promissory file 100.

FIG. 3 step 7 depicts delegated currency issuer 300 sending cryptographic promissory file(s) 100 to authority service 200 to receive an authorized signature for each file.

FIG. 3 step 8 depicts authority service 200 signing the latest signature block for each cryptographic promissory file 100, updating each file with an authorized signature.

FIG. 3 step 9 depicts authority service 200 returning the authorized cryptographic promissory file(s) 100 to delegated currency issuer 300.

FIG. 3 step 10 depicts delegated currency issuer 300 sending the authorized cryptographic promissory file(s) 100 to remote device 500.

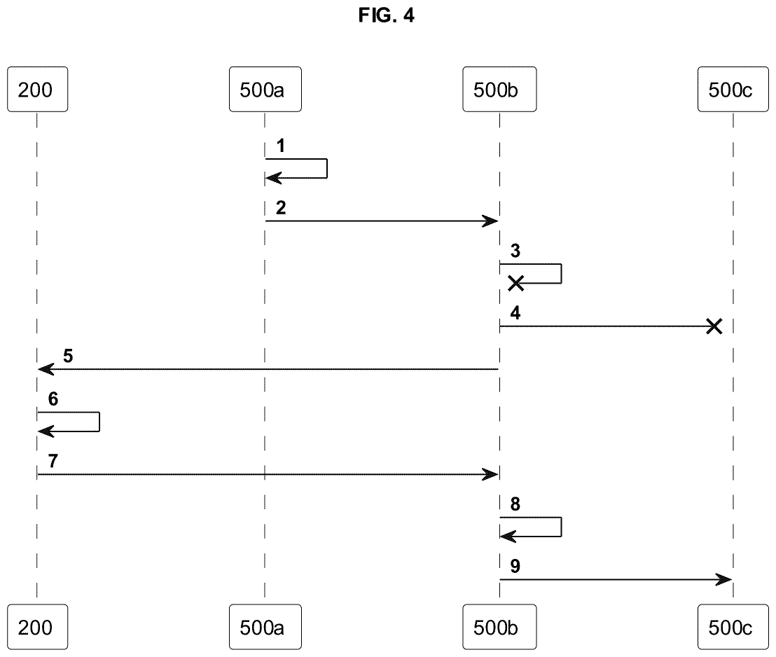

We now turn to FIG. 4.

FIG. 4 depicts sequence diagram of a peer-to-peer cryptographic promissory file 100 transactions between remote devices 500a, 500b and 500c and authority service 200.

Illustrated in FIG. 4 is a “pending-authorization” cryptographic promissory file 100 transaction between 500a and 500 b, demonstrating the ability for a cryptographic promissory file 100 to be sent between two peers without the presence of an authorized signature from the monetary authority service 200.

FIG. 4 step 1 depicts remote device 500 a locally signing cryptographic promissory file 100.

FIG. 4 step 2 depicts remote device 500 a sending the promissory file 100 to remote device 500b directly. Cryptographic promissory file(s) 100 are considered “pending-authorization” and are not considered settled until authority service 200 provides an authorized signature for each promissory file 100. Notably, this interaction demonstrates the ability for a promissory file 100 to be sent between peers over agnostic OSI networks without the need for a third party to be involved in the transacting of a cryptographic promissory file 100.

FIG. 4 step 3 illustrates that the promissory file 100 is not considered settled until 500b is able to obtain an authorized signature for the promissory file 100 and cannot be transferred by 500b until having received an authorized cryptographic signature for the promissory file 100 from authority service 200. In examples, the authorized signature of a promissory file 100 can be obtained asynchronously from an authority service 200, for example when remote device 500b connects to the Internet. FIG. 4 step 3 further illustrates that 500a can be able to send a fraudulent or “double spent” promissory file 100 to 500b, and that 500b will not be able to determine whether the promissory file 100 has been previously transferred in a prior transaction without receiving an authorized signature from authority service 200 for the cryptographic promissory file 100 validating ownership.

FIG. 4 steps 4 through 9 illustrates that the promissory file 100 cannot be sent to another peer, 500c, without 500b first receiving an authorized signature from authority service 200 for the latest signature block 102 of the promissory file 100. Remote device 500b is prohibited from further transferring “pending-authorization” cryptographic promissory file(s) 100 to remote device 500c until receiving an authorized signature for each cryptographic promissory file 100. In examples, sending “pending-authorization” promissory file(s) 100 should only be done when the counter parties are able to trust each other, or when counter-party risk is low. In examples, sending a “pending-authorization” promissory file 100 can enable the offline transacting of a promissory file 100. This feature can be of importance in one or more examples of the disclosed methods and apparatus, specifically during instances when internet connection cannot be available but a transfer of cryptographic promissory file(s) 100 is desired, or as a fault tolerance feature when a monetary authority service 200 or delegated currency issuer service 300 is unavailable.

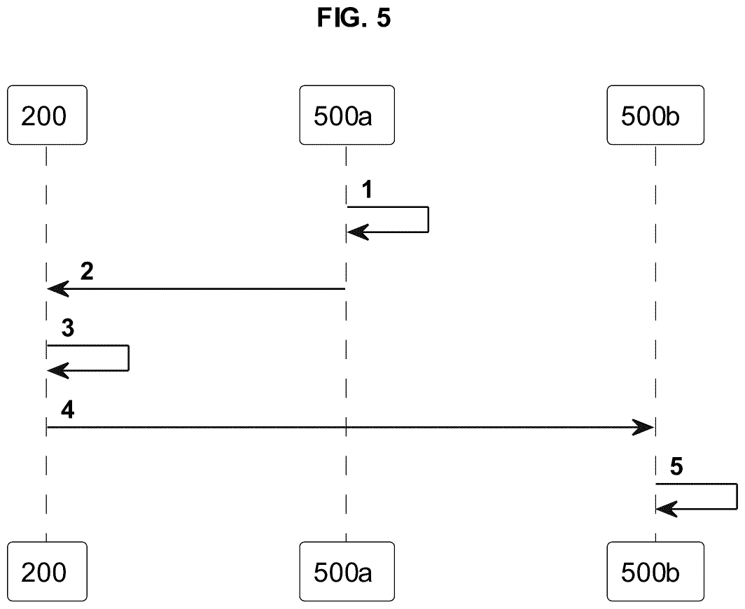

We now turn to FIG. 5.

FIG. 5 depicts a sequence diagram where remote device 500 a sends cryptographic promissory file(s) 100 to authority service 200 to authorize cryptographic promissory file(s) 100 before remitting to remote device 500b.

FIG. 5 step 1 indicates remote device 500a locally providing a secured signature on cryptographic promissory file(s) 100 assigning ownership to 500b using the public key identity of remote device 500b.

FIG. 5 step 2 depicts remote device 500a requesting an authorized signature for cryptographic promissory file(s) 100 from an authority service 200.

FIG. 5 step 3 indicates authority service 200 verifying cryptographic promissory file(s) 100, providing an authorized signature for the latest signature block 102 for each cryptographic promissory file 100.

FIG. 5 step 4 illustrates in one embodiment of the disclosed methods and apparatus authority service 200 can remit the fully authorized cryptographic promissory file(s) 100 to remote device 500b using its public key identity found in the cryptographic promissory file 100, without routing through remote device 500a.

FIG. 5 step 5 illustrates that cryptographic promissory file(s) 100 received by remote device 500b can be verified to be owned by remote device 500b.

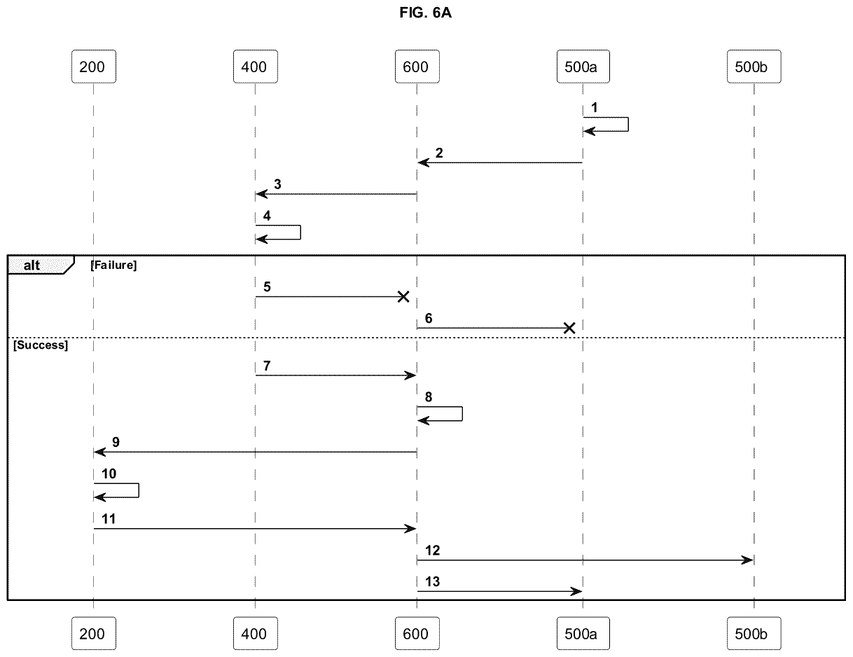

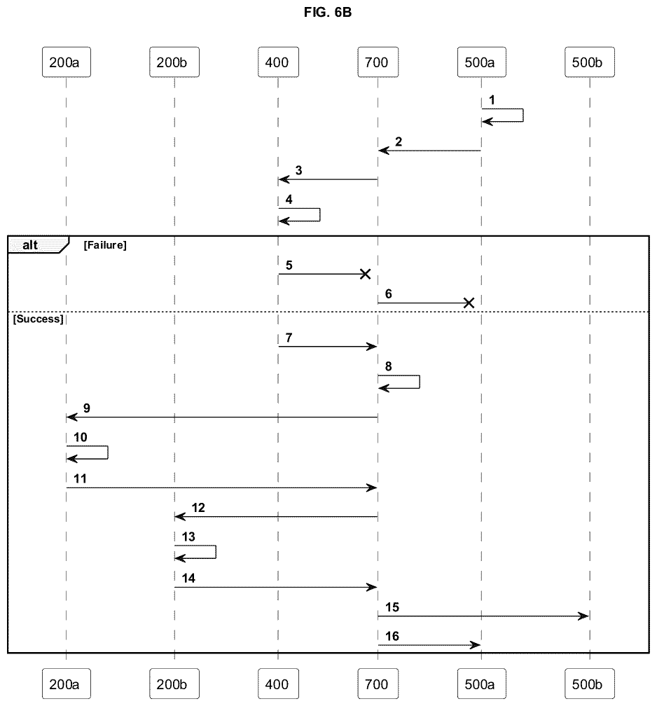

We now turn to FIG. 6A.

FIG. 6A illustrates remote device 500 a sending cryptographic promissory file(s) 100 to remote device 500b using a remittance service 600 to perform an atomic transfer of cryptographic promissory file(s) 100 from remote device 500a in excess of the amount of funds to be transferred to remote device 500b. In examples, remote device 500a can desire to use remittance service 600 to ensure 500b is unable to withhold any residual change that would otherwise be returned to 500a if the remitting service 600 was not used.

FIG. 6 A step 1 illustrates remote device 500a assigning ownership of cryptographic promissory file(s) 100 to remittance service 600.

FIG. 6 A step 2 illustrates remote device 500 a sending a remittance request with “pending authorization” cryptographic promissory file(s) 100 to remittance service 600 for processing.

FIG. 6 A step 3 illustrates remittance service 600 requesting sanctions checks for remote devices 500a and 500b based on their public key identities associated with registered personally identifiable information (PII).

FIG. 6 A step 4 illustrates sanctions service 400 screening the identities of remote devices 500a and 500b.

FIG. 6A step 5 indicates sanctions check failure for either remote device 500 a or 500 b, returning a failed response to remittance service 600.

FIG. 6A step 6 illustrates remittance service 600 returning a failure response to remote device 500 a.

FIG. 6A step 7 illustrates a successful response from sanctions service 400 to remittance service 600.

FIG. 6 step 8 illustrates remittance service 600 assigning cryptographic promissory file(s) 100 to remote device 500 b. Additionally, FIG. 6A step 8 illustrates remittance service 600 assigning cryptographic promissory file(s) 100 to remote device 500a for residual change to be returned.

FIG. 6A steps 9 through 11 indicate remittance service 600 requesting an authorized signature for each cryptographic promissory file 100.

FIG. 6A step 12 illustrates remittance service 600 remitting cryptographic promissory file(s) 100 to remote device 500 b.

FIG. 6A step 13 illustrates remittance service 600 returning cryptographic promissory file(s) 100 to remote device 500a in the residual amount owed to remote device 500a.

We now turn to FIG. 6B.

FIG. 6B depicts a sequence diagram illustrating remote device 500a remitting funds to remote device 500b denominated in a foreign currency using a foreign currency exchange service 700. Foreign currency exchange service 700 communicates with various monetary authority service 200 instances for receiving an authorized signature in their respective currency denominations. Foreign currency exchange service 700 additionally communicates with sanctions screening service 400. Foreign currency exchange service 700 can hold promissory file(s) 100 denominated in various currencies (e.g., USD, EUR, GBP, JPY, etc.).

FIG. 6B steps 1 through 11 are like FIG. 6A steps 1 through 11. FIG. 6B introduces additional steps 12 through 14 to illustrate the communication with a foreign currency authority service 200b.

FIG. 6B steps 9 through 14 demonstrates foreign currency exchange service 700 requests authorization signatures from authority services 200a and 200b to complete a foreign currency exchange.

FIG. 6B steps 15 and 16 illustrate the remittance cryptographic promissory file(s) 100 to remote devices 500b and residual change to 500a, each receiving the monetary amounts in foreign and local currency denominations, respectively.

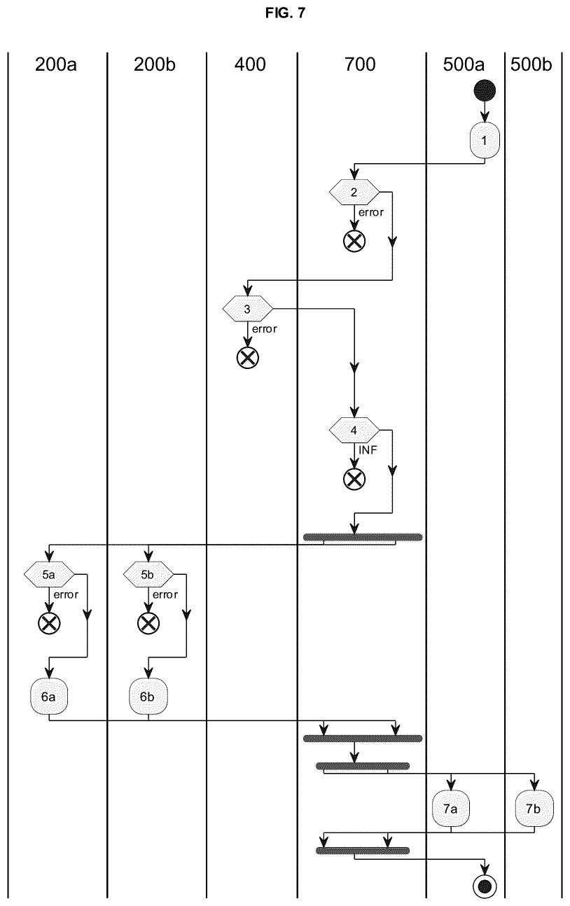

We now turn to FIG. 7.

FIG. 7 illustrates an exemplary flow chart with foreign exchange service 700 remitting cryptographic promissory files 100 for remote device 500 a to remote device 500 b. FIG. 7 depicts foreign exchange service 700 checking sanctions service 400 before requesting authorized signatures for cryptographic promissory files 100 from authority services 200a and 200b corresponding to the local and foreign denominated cryptographic promissory files 100 being exchanged.

FIG. 7 step 1 indicates remote device 500 a assigning ownership of cryptographic promissory files 100 to foreign exchange service 700.

FIG. 7 step 2 indicates foreign exchange service 700 validating the request from remote device 500 a, ensuring cryptographic promissory files 100 are correctly assigned to foreign exchange service 700 for processing.

FIG. 7 step 3 illustrates sanctions service 400 performing anti-money laundering checks on remote devices 500a and 500b, if either remote device 500 fails sanctions screening, the transaction is aborted.

FIG. 7 step 4 indicates foreign exchange service 700 checking its treasury holdings to perform the exchange. If foreign exchange service 700 does not have the corresponding foreign denominated cryptographic promissory file(s) 100 to complete the exchange, the transaction is aborted.

FIG. 7 steps 5a, 5b, 6a, and 6b describe concurrent processing of authorizing cryptographic promissory file(s) 100 by authority services 200 a and 200b representing two foreign monetary authorities authorizing their respective cryptographic promissory files 100.

FIG. 7 steps 7a and 7b illustrates foreign currency exchange service 700 remitting cryptographic promissory files 100 to remote device 500a and 500b in their respective foreign and local denominated currencies.

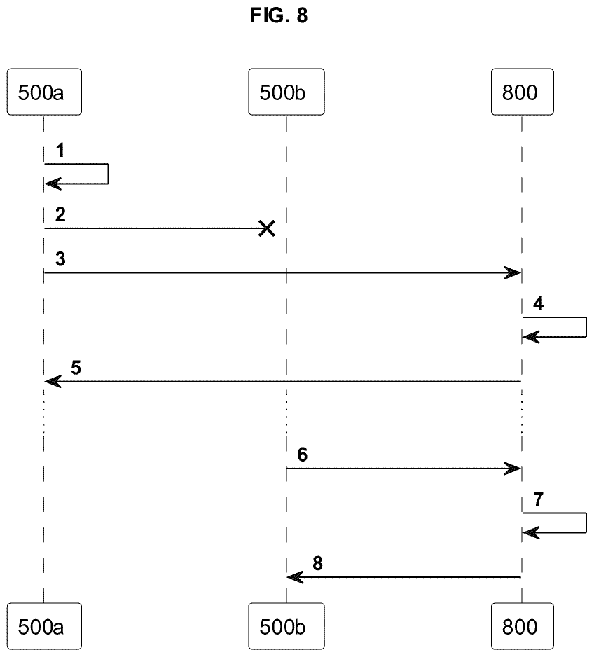

We now turn to FIG. 8.

FIG. 8 illustrates a sequence diagram demonstrating a custodian service 800, holding cryptographic promissory file(s) 100 for remote devices 500a and 500b.

FIG. 8 step 1 indicates remote device 500 a cryptographically signing ownership of cryptographic promissory file(s) 100 to remote device 500b.

FIG. 8 step 2 illustrates remote device 500a is unable to send cryptographic promissory file(s) 100 to remote device 500b.

FIG. 8 step 3 illustrates remote device 500a sending cryptographic promissory file(s) 100 to custodian service 800 for the benefit of remote device 500 b.

FIG. 8 step 4 illustrates custodian service 800 storing cryptographic promissory file(s) 100.

FIG. 8 step 5 illustrates remote device 500b requesting from custodian service 800 cryptographic promissory file(s) 100 belonging to remote device 500b. Remote device 500b must provide proof of its public key ownership by cryptographically signing a byte payload with its corresponding private key.

FIG. 8 step 6 illustrates custodian service 800 retrieving cryptographic promissory file(s) 100 belonging to remote device 500b.

FIG. 8 step 7 illustrates custodian service 800 responding to remote device 500b with cryptographic promissory file(s) 100. Custodian service 800 serves as a mailbox solution for cryptographic promissory files 100, using the public key identities to authenticate and claim ownership of the cryptographic promissory files 100. In examples, cryptographic promissory files 100 can be stored in a relational database, key-value database, file system or other persistent storage solution. In one embodiment of the disclosed methods and apparatus, custodian service 800 provides a high availability storage and retrieval solution in the event a remote device 500 is unreachable to receive a cryptographic promissory file 100.

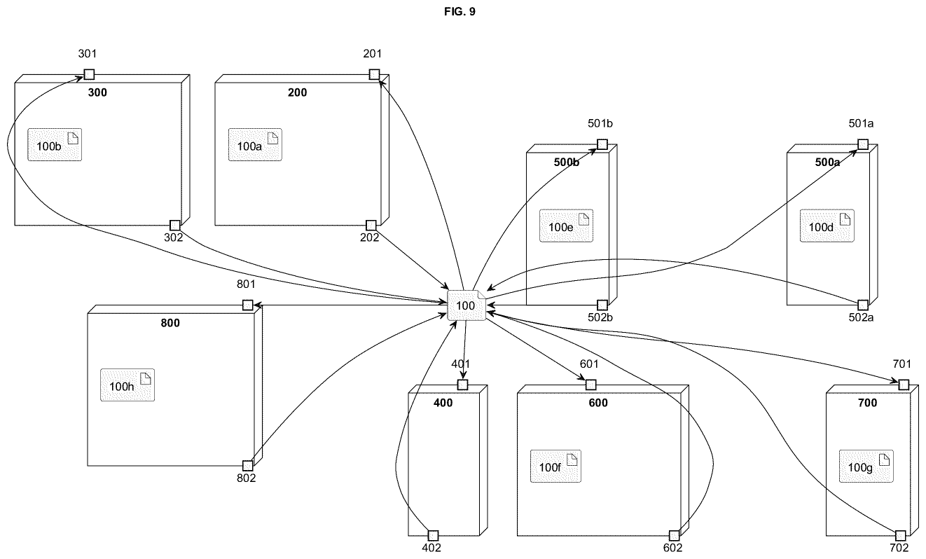

We now turn to FIG. 9.

FIG. 9 illustrates a deployment diagram of systems for processing cryptographic promissory files 100. FIG. 9 depicts cryptographic promissory file 100 as acted up by authority service 200, delegated currency issuer service 300, sanctions service 400, remote devices 500a and 500b, remittance service 600, foreign exchange service 700 and custodian service 800. Each service is illustrating with an interface for receiving and sending cryptographic promissory files 100. FIG. 9 depicts authority service 200 with input 201 and output 202 interfaces for authorizing cryptographic promissory files 100. FIG. 9 depicts delegated currency issuer service 300 with input 301 and output 302 for issuing cryptographic promissory files 100. FIG. 9 illustrates sanctions service 400 with input 401 and output 402 for sanctions screening of cryptographic promissory files 100. FIG. 9 illustrates remote devices 500a and 500b with inputs 501a and 501b and outputs 502a and 502b, respectively, for receiving and sending cryptographic promissory files 100. FIG. 9 illustrates remittance service 600 with input 601 and output 602 for remitting and returning residual change of cryptographic promissory files 100. FIG. 9 illustrates foreign exchange service 700 with input 701 and output 702 for exchanging cryptographic promissory files 100 into foreign denominated cryptographic promissory files 100, remitting and returning residual change of cryptographic promissory files 100. FIG. 9 illustrates custodian service 800 with input 801 and output 802 for storing and retrieving cryptographic promissory files 100 for benefit of cryptographic promissory file 100 owners.

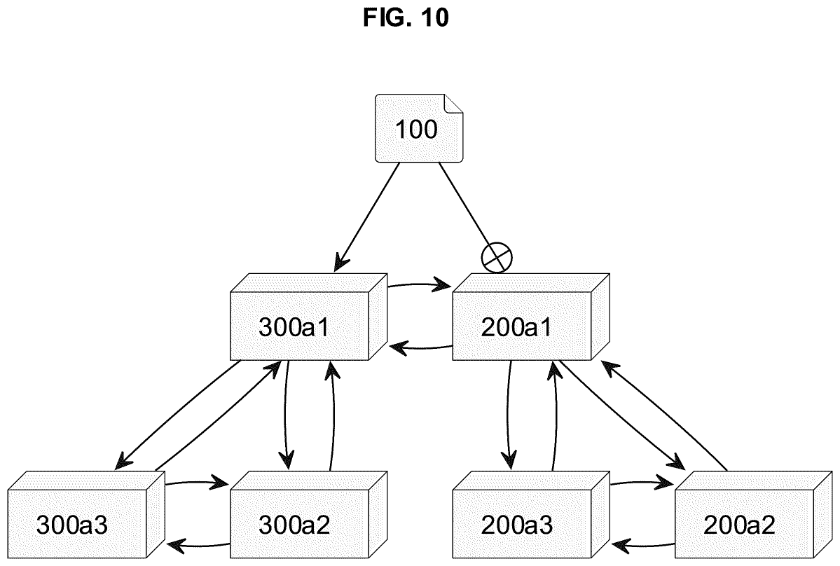

We now turn to FIG. 10.

FIG. 10 illustrates a deployment diagram indicating the replication of cryptographic promissory file 100 amongst authority services 200a1, 200a2, and 200a3 and delegated currency issuer services 300a1, 300a2, and 300a3. FIG. 10 depicts that if authority service 200a1 is unavailable to receive cryptographic promissory file(s) 100, delegated currency issuer services 300a1, 300a2, and 300a3 can replicate cryptographic promissory file 100 state with authority services 200a1, 200a2, and 200a3. FIG. 10 illustrates fault tolerances amongst authority service 200 and delegated currency issuer service 300. In examples, different replication algorithms (e.g., Raft, Paxos, etc.) can be used to maintain a consensus amongst replicated services for asserting the current state of cryptographic promissory files 100. In examples, cryptographic promissory files 100 can be stored on a variety of different persistent volumes, including databases with built-in multi-region replication and fault tolerances.

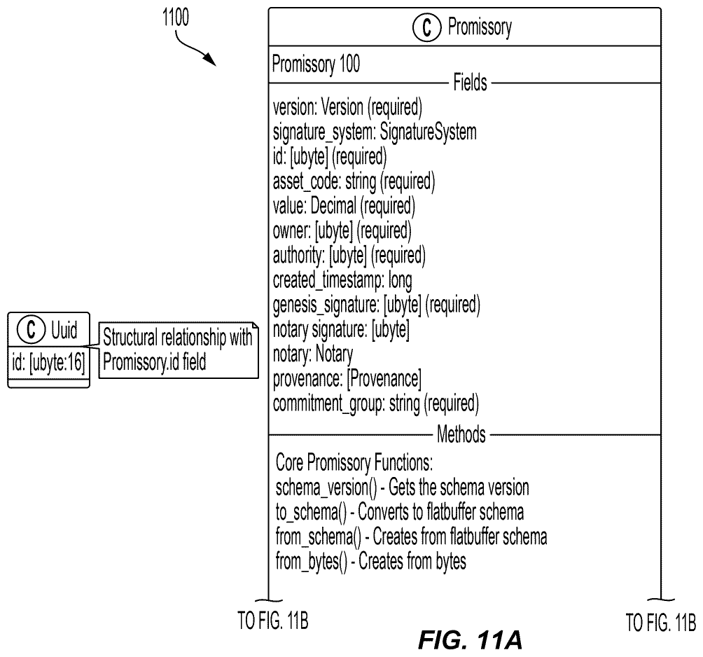

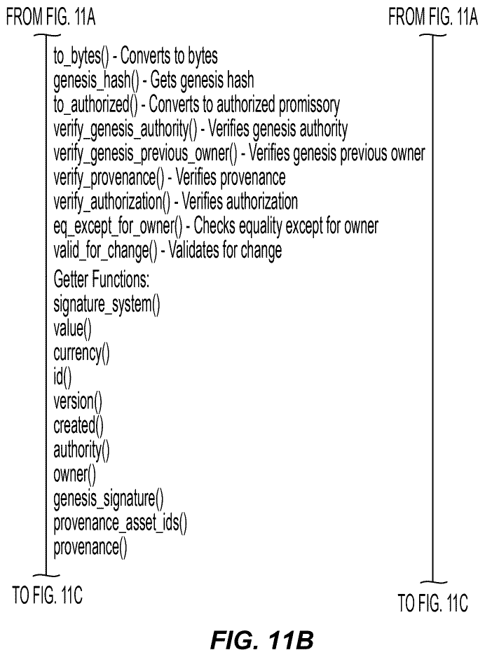

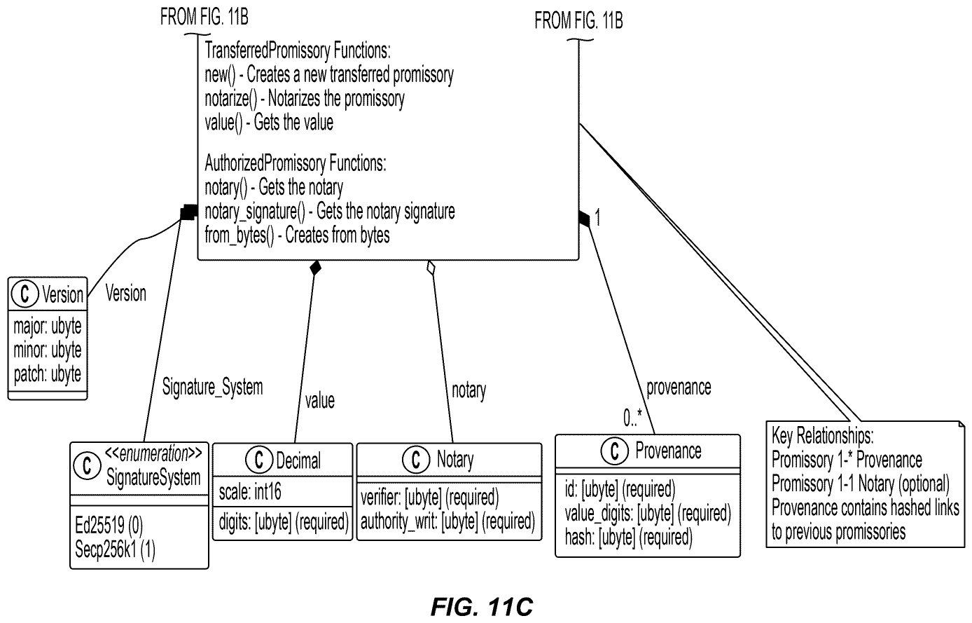

We now turn to FIGS. 11A-11C.

FIGS. 11A-11C depict an exemplary class diagram 1100 of a cryptographic promissory file instance in accordance with embodiments of the disclosed methods and apparatus. In one or more embodiments, the promissory file can include information describing a universally unique identifier, a version number, a cryptographic signature system, a decimal amount, an asset code, a cryptographic public key matching a cryptographic signing key, a cryptographic public key of the asset owner, a cryptographic public key of the asset authority, a promissory file issuance date timestamp generated by an operating system, a cryptographic signature by a notary of a latest promissory file hash, a cryptographic signature by a previous promissory file owner of a latest promissory file hash, a notary that authorizes a transfer (e.g. including information describing the notary cryptographic public key and a signature of the notary cryptographic public key from the asset authority), a list of asset provenance (e.g. comprising an identifier of a previous promissory file, a respective cryptographic hash of the previous promissory file, and a respective decimal amount deducted from a previous promissory file to add to the value of the new promissory file), a commitment group configured to link the new promissory file to the transaction identifier, commitment identifiers between involved parties, and a group name. The promissory file can also include information describing methods to retrieve fields described above (e.g., versions, genesis hash, etc.), converts to and from serialization schemas, to and from bytes to object, authorize the promissory, verify authority and previous owners, verify provenance list, verify authorization, verify all fields except the owner, verify a current promissory is distinct from a change promissory, create a new transferred promissory, notarize the promissory, and retrieve a value of the promissory file.

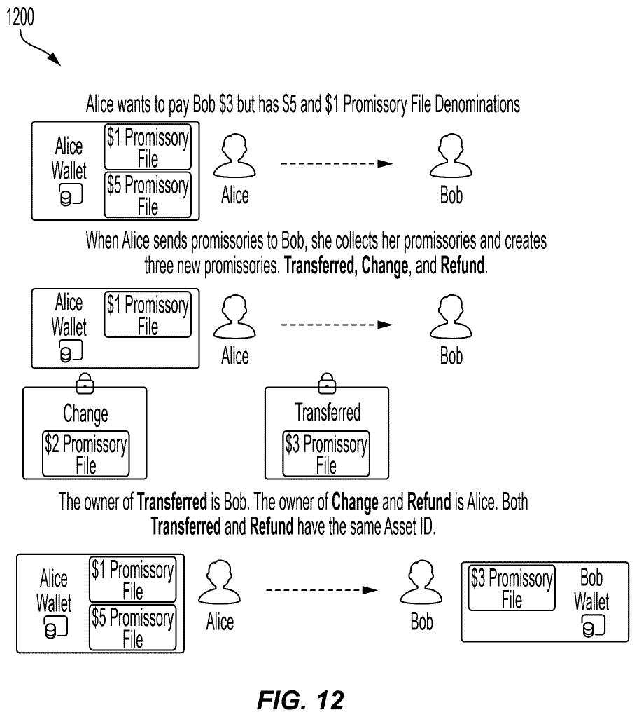

We now turn to FIG. 12.

FIG. 12 depicts an example flowchart 1200 of a method where a sender transfers one or more promissory files and a process in which a transfer promissory file, the change promissory file, the refund promissory file, or a combination thereof is created and remitted to a sender, receiver, or both depending on amounts owed.

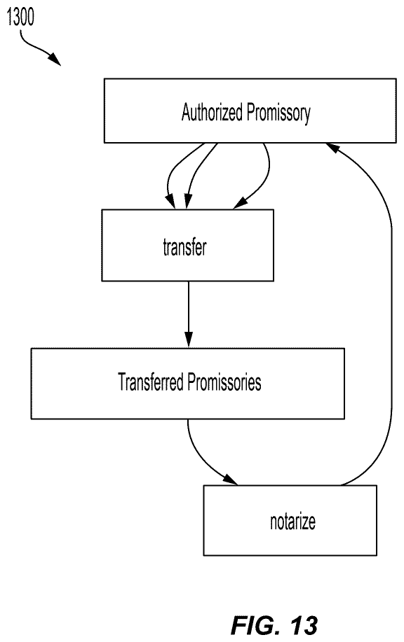

We now turn to FIG. 13.

FIG. 13 depicts a lifecycle 1300 of a promissory file state when transferring ownership to having the promissory file authorized by a notary, using methods defined with the promissory file to transfer ownership as well as to have the promissory file authorized by the notary.

Authorization by the notary can include notarization.

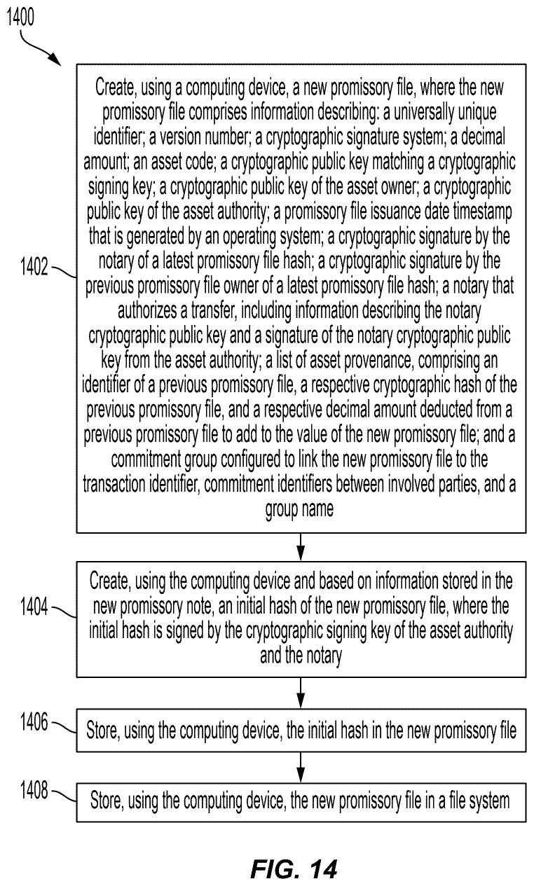

We now turn to FIG. 14.

FIG. 14 depicts a non-limiting example method 1400 for constructing a new promissory file. In examples, the new promissory file can be cryptographically signable, verifiable, and can represent an asset issued by an asset authority.

The method 1400 can be used to implement constructing a new promissory file. In an embodiment, the method 1400 can be implemented in a form of a set of computer-executable instructions. In examples, computer-executable instructions can include routines, programs, objects, components, data structures, procedures, operations, modules, functions, or a combination thereof, as non-limiting examples. Such computer-executable instructions can be executed by one or more programmed processors or co-processors.

The order in which the method 1400 is described is not intended to be construed as a limitation, and any number of the described features can be combined in any order to implement the method 1400 or alternate methods for constructing a new promissory file. Additionally, individual features can be omitted, as is practicable, from the method 1400 without departing from the scope of the subject matter described herein. Furthermore, the method 1400 can be implemented by any suitable hardware, in software, in firmware, or a combination thereof, such as the apparatus described hereby.

As shown in FIG. 14, at step 1402, one or more of the devices described herein can create a new promissory file. In an example, the new promissory file can include information describing (a) a universally unique identifier; (b) a version number; (c) a cryptographic signature system; (d) a decimal amount; (e) a cryptographic public key matching a cryptographic signing key; (f) a cryptographic public key of the asset owner; (g) a cryptographic public key of the asset authority; (h) a promissory file issuance date timestamp that is generated by an operating system; (i) a cryptographic signature by the notary of a latest promissory file hash; (j) a cryptographic signature by the previous promissory file owner of a latest promissory file hash; (k) a notary that authorizes a transfer, including information describing the notary cryptographic public key and a signature of the notary cryptographic public key from the asset authority; (l) a list of asset provenance, comprising an identifier of a previous promissory file, a respective cryptographic hash of the previous promissory file, and a respective decimal amount deducted from a previous promissory file to add to the value of the new promissory file; and (m) a commitment group configured to link the new promissory file to the transaction identifier, commitment identifiers between involved parties, (n) a group name, or a combination thereof.

As shown in FIG. 14, at step 1404, one or more of the devices described herein can create, based on information stored in the new promissory note, an initial hash of the new promissory file. The initial hash can be signed by the cryptographic signing key of the asset authority. The initial hash can be signed by the cryptographic signing key of the notary.

As shown in FIG. 14, at step 1406, one or more of the devices described herein can store the initial hash in the new promissory file.

As shown in FIG. 14, at step 1408, one or more of the devices described herein can store the new promissory file in a file system.

In an example, the method 1400 can further include (i) reading the new promissory file; and (ii) returning values stored in the new promissory file.

In an example, the method 1400 can further include (i) calculating a next promissory file hash by creating a new hash digest of the new promissory file and a cryptographic public key of an intended recipient to transfer ownership of the new promissory file to the intended recipient; and (ii) cryptographically signing the new promissory file by (a) the asset authority after the new promissory file is created and prior to an initial transfer of ownership; or (b) a previous owner of the new promissory file when the new promissory file is subsequently transferred; and (iii) cryptographically signing the new promissory file by the notary of the new hash digest.

In an example, the method 1400 can further include (i) searching a file system directory for instances of previous promissory files to create a list of previous promissory files; and (ii) returning, from read file buffers, information in the list of previous promissory files.

In an example, the method 1400 can further include saving, in the file system, a file name for a promissory file instance based on (i) a character string representation of the asset code; (ii) the decimal amount; and (iii) the universally unique identifier.

In an example, the method 1400 can further include issuing the new promissory file.

In an example, the method 1400 can further include ordering comparison promissory files, where the ordering is based on decimal normalized amounts of the comparison promissory files.

In an example, the method 1400 can further include normalizing a promissory file instance amount against promissory files having different decimal place precisions.

In an example, the method 1400 can further include (i) calculating an immediate previous hash of an immediate previous promissory file; and (ii) returning the immediate previous hash of the immediate previous promissory file.

In an example, the method 1400 can further include retrieving, from the file system, latest ownership details of the new promissory file.

In an example, the method 1400 can further include retrieving, from the file system (i) an identifier of the immediate previous promissory file; (ii) an asset value of the immediate previous promissory file; (iii) a hash of the immediate previous promissory file; or (iv) a combination thereof.

In an example, the method 1400 can further include (i) receiving a cryptographic public key of a recipient; (ii) assigning ownership of the new promissory file by using a cryptographic public key of the recipient to calculate a next promissory file hash; and cryptographically signing the next promissory file hash with a cryptographic signing key of a current promissory file owner; (iii) supplying a cryptographic signature and a cryptographic public address of the recipient for use in a cryptographic verification and construction of a next promissory file hash; (iv) updating a state of the new promissory file; and (v) returning latest promissory data in the new promissory file In an example, the method 1400 can further include supplying a cryptographic signature from a notary of a calculated next promissory file hash for use in cryptographic verification and construction of a next promissory file hash.

In an example, the method 1400 can further include (i) maintaining network connectivity to the notary, wherein the notary retains a copy of previous promissory files; and (ii) communicating, with the notary, as a portion of a transfer of the new promissory file, only the immediate previous promissory file identifier, the initial hash, and the respective decimal amount deducted from a previous promissory file to add to the value of the new promissory file.

In an example, the method 1400 can further include ensuring, by the notary when a plurality of parties are exchanging digital promissory files, that either all transfers of the digital promissory files in the exchange complete or none of the transfers of the digital promissory files in the exchange complete.

In an example, the method 1400 can further include to (i) verifying a cryptographic correctness of the promissory file solely from information stored in the promissory file; (ii) computing, using the computing device, a provenance promissory file hash; (iii) recursing, using the computing device, a list of asset provenance files; (iv) verifying notary and previous owner cryptographic signatures for a latest promissory file hash and from a list of provenance promissory files; and (v) verifying correctness of the promissory file without reliance on network connectivity.

In an example, the method 1400 can further include (i) receiving, from the asset authority, an asynchronous cryptographic signature of the promissory file that is (a) a signature for a current promissory file hash or; (b) a signature for pre-authorizing a next computed promissory file hash based on a cryptographic public key of a recipient; and (ii) updating an authorized signature of the promissory file.

In an example, the method 1400 can further include (i) organizing a plurality of promissory files for a given cryptographic public key in a binary heap to sort from highest to lowest respective decimal normalized promissory file amounts; and (ii) calculating a nearest balance of an account to a parameterized asset amount from a sorted collection.

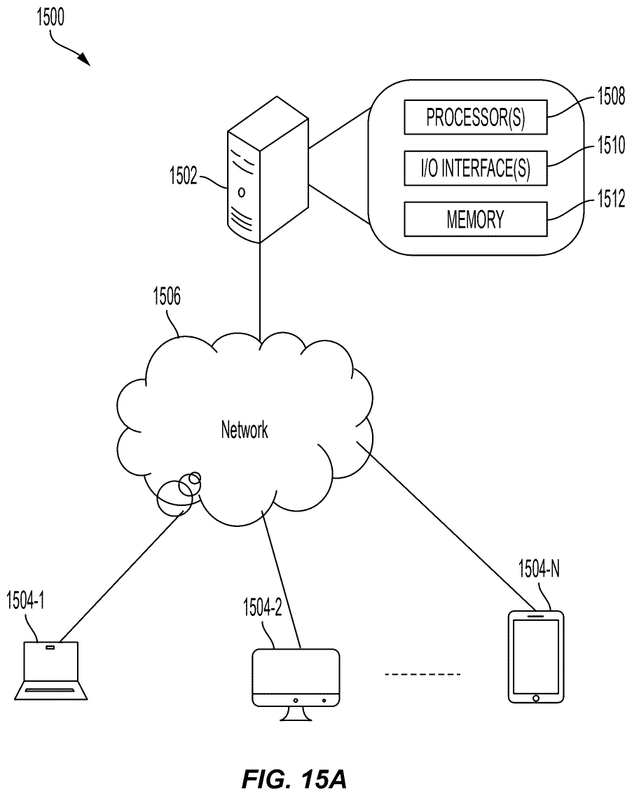

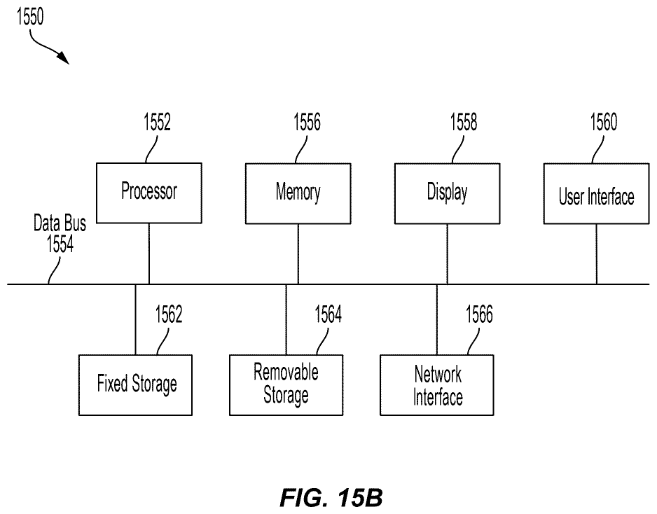

We now turn to FIG. 15A.

FIG. 15A depicts a network implementation 1500 of a system 1502. One or more users can access the system 1502 through one or more user devices 1504-1, 1504-2 . . . 1504-N, collectively referred to as user devices 1504, hereinafter, or applications residing on the user devices 1504.

Although the disclosure is explained considering that the system 1502 is implemented on a server, the system 1502 can be implemented in other forms of a computing device or system, such as a laptop computer, a desktop computer, a notebook, a workstation, a virtual environment, a mainframe computer, a server, a network server, or a cloud-based computing environment. It will be understood that the system 1502 can be accessed by multiple users through one or more user devices 1504-1, 1504-2 . . . 1504-N.

In one implementation, the system 1502 can comprise a cloud-based computing environment in which the user can operate individual computing systems configured to execute remotely located applications. Examples of the user devices 1504 can include, but are not limited to, a portable computer, a personal digital assistant, a handheld device, a workstation, or a combination thereof. The user devices 1504 can be communicatively coupled to the system 1502 through a network 1506.

In one implementation, the network 1506 can be a wireless network, a wired network, or a combination thereof. The network 1506 can be implemented as one of several different types of networks, including but not limited to an intranet, local area network (LAN), wide area network (WAN), the Internet, or a combination thereof. The network 1506 can be a dedicated network or a shared network. A shared network can be an association of different types of networks that use a variety of protocols, for example, Hypertext Transfer Protocol (HTTP), Transmission Control Protocol/Internet Protocol (TCP/IP), or Wireless Application Protocol (WAP) to communicate with one another. Further, the network 1506 can include a variety of network devices, including routers, bridges, servers, computing devices, storage devices, or a combination thereof.

In an embodiment, system 1502 can include at least one processor 1508, an input/output (I/O) interface 1510, and a memory 1512. The processor 1508 can be implemented as one or more microprocessors, microcomputers, microcontrollers, digital signal processors, Central Processing Units (CPUs), state machines, logic circuitries, devices that manipulate signals based on operational instructions, or a combination thereof. Among other capabilities, the at least one processor 1508 can be configured to fetch and execute computer-readable instructions stored in the memory 1512.

The in/out (I/O) interface 1510 can include software and hardware interfaces, for example, a web interface, a graphical user interface (GUI, UI), and the like. The I/O interface 1510 can allow the system 1502 to interact with the user directly or through at least one of the client devices 1504-1 to 1504-N. Further, the I/O interface 1510 can enable the system 1502 to communicate with other computing devices, such as web servers and external data servers (not shown). The I/O interface 1510 can facilitate communications and data transfer within a wide variety of networks and protocol types, including wired networks (for example, Local Area Network or cable) and wireless networks (such as wireless local area network, a cellular network, or a satellite network). The I/O interface 1510 can include one or more ports for connecting a number of devices to one another or to another server.

The memory 1512 can include a computer-readable medium or computer program product. Non-limiting examples include volatile memory, such as static random-access memory (SRAM) and dynamic random-access memory (DRAM), and/or non-volatile memory, such as read only memory (ROM), erasable programmable ROM, flash memories, hard disks, Solid State Disks (SSD), optical disks, and magnetic tapes. The memory 1512 can include routines, programs, objects, instructions, modules, components, or data structures which perform particular tasks or implement particular abstract data types. The memory 1512 can include programs or instructions that supplement applications and functions of the system 1502. In an embodiment, the memory 1512 can serve as a repository for storing data processed, received, generated or a combination thereof by one or more programs or coded instructions.

We now turn to FIG. 15B.

FIG. 15B depicts an example diagram of an example computing device 1550 suitable for implementing examples of the disclosed subject matter. For example, at least a portion of the computing device 1550 can be suitable for use as a component part of the system 1502, at least one of the user devices 1504-1 to 1504-N, or a combination thereof. In another example, at least a portion of the computing device 1550 can be coupled to the network 1506.

In examples, a machine configured to perform at least a portion of a method described herein can include at least a portion of the example computing device 1550, at least a portion of the system 1502, or both, configured with computer-executable instructions to perform at least a portion of a technique described hereby, where the computer-executable instructions can be stored on a non-transitory computer-readable data storage device, a non-transitory computer-readable medium, or both.

In examples, aspects of the computing device 1550 can be implemented at least in part in a desktop computer, a laptop computer, a server, a mobile device, a special-purpose computer, a non-generic computer, an electronic device described hereby (as is practicable), the like, or a combination thereof. In some examples, the disclosed subject matter can be implemented in, and used with, hardware devices, computer network devices, the like, or a combination thereof. The configuration depicted in FIG. 15B is an illustrative example and is not limiting.

In some examples, the computing device 1550 can include a processor 1552, a data bus 1554, a memory 1556, a display 1558, a user interface 1560, a fixed storage device 1562, a removable storage device 1564, a network interface 1566, the like, or a combination thereof. These elements are described in further detail herein.

The processor 1552 can be a hardware-implemented processing unit configured to control at least a portion of operation of the computing device 1550. The processor 1552 can perform logical and arithmetic operations based on processor-executable instructions stored within the memory 1556. The processor 1552 can be configured to execute instructions that cause the processor 1552 to initiate at least a part of a method described hereby. In an example, the processor 1552 can interpret instructions stored in the memory 1556 to initiate at least a part of a method described hereby. In an example, the processor 1552 can execute instructions stored in the memory 1556 to initiate at least a part of a method described hereby. The instructions, when executed by the processor 1552, can transform the processor 1552 into a special-purpose processor that causes the processor to perform limited functions including at least a part of a function described hereby. The processor 1552 can also be referred to as a central processing unit (CPU), a special-purpose processor (e.g. a non-generic processor), or both.

In some examples, the computing device 1550 can implement machine-learning techniques (e.g. using a Convolutional Neural Network (CNN), etc.) to collect information, process information, or both. In some examples, the provided apparatuses can be configured to perform a neural network convolution on at least a portion of information described herein.

As used herein, the acronym “CNN” refers to a Convolutional Neural Network. A CNN is a type of feed-forward neural network that can process and collect portions of input information. The CNN can receive input information and can leverage parallel processing capabilities to perform at least a portion of a method described herein.

As used herein, the acronym “LSTM” refers to a Long Short-Term Memory neural network. An LSTM is a type of recurrent feed-forward neural network architecture which can be trained to classify input information. An LSTM can be trained on a training data set, such as a training data set having known-accurate information. Thus, the LSTM can receive input information and perform at least a portion of a method described herein. The LSTM includes intermediate hidden layers of processing units which perform a function on data input from a preceding layer. The output from a hidden layer is a “hidden state.” The hidden state is “hidden” in the sense that the hidden state is not an output from an output layer. In some examples, the provided apparatuses can be configured to perform a neural network convolution, using a hidden layer, on at least a portion of information described herein.

In some examples, the provided methods can include performing a neural network convolution on at least a portion of information described herein. In some examples, the provided methods can include using a machine learning model to perform at least a portion of a method described herein. In some examples, the provided methods can include training a machine learning model to perform at least a portion of a method described herein. In some examples, information stored in an information storage device of the computing device 1550 can be transferred to another computing device.

In some examples, the provided techniques can advantageously improve functioning of machine learning models configured to perform at least a portion of a method described herein. For example, the provided techniques can advantageously improve processing techniques of machine learning models configured to perform at least a portion of a method described herein. The provided techniques can advantageously improve functioning of computers configured to perform at least a portion of a method described herein and other technologies configured to perform at least a portion of a method described herein.

The processor 1552 can comprise or be a component of a physical processing system implemented with one or more processors. In some examples, the processor 1552 can be implemented with at least a portion of: a microprocessor, a microcontroller, a digital signal processor (DSP) integrated circuit, a field programmable gate array (FPGA), a programmable logic device (PLD), an application-specific integrated circuit (ASIC), a controller, a state machine, a gated logic circuit, a discrete hardware component, a dedicated hardware finite state machine, a finite state machine configured to perform at least a portion of a stage of contract negotiation, finite state machine configured to perform execution of at least a portion of a contract-based transaction, a suitable physical device configured to manipulate information (e.g., calculating, logical operations, the like, or a combination thereof), the like, or a combination thereof.

The data bus 1554 can couple components of the computing device 1550. The data bus 1554 can enable information communication between the processor 1552 and one or more components coupled to the processor 1552. In some examples, the data bus 1554 can include a data bus, a power bus, a control signal bus, a status signal bus, the like, or a combination thereof. In an example, the components of the computing device 1550 can be communicatively coupled together to communicate with each other using a different suitable mechanism.

The memory 1556 generally represents any type or form of volatile storage device, non-volatile storage device, medium, the like, or a combination thereof. The memory 1556 can store data (e.g. a database), processor-readable instructions, the like, or a combination thereof. In an example, the memory 1556 can store data, load data, maintain data, or a combination thereof. In an example, the memory 1556 can store processor-readable instructions, load processor-readable instructions, maintain processor-readable instructions, or a combination thereof. In some embodiments, the memory 1556 can store computer-readable instructions configured to cause a processor (e.g. the processor 1552) to initiate performing at least a portion of a method described hereby. The memory 1556 can be a main memory configured to store an operating system, an application program, the like, or a combination thereof. The memory 1556 can store a basic input-output system (BIOS) which can control basic hardware operation such as interaction of the processor 1552 with peripheral components. The memory 1556 can also include a non-transitory machine-readable medium configured to store software. Software can mean any type of instructions, whether referred to as at least one of software, firmware, middleware, microcode, hardware description language, the like, or a combination thereof. Processor-readable instructions can include code (e.g., in source code format, in binary code format, executable code format, or in any other suitable code format).

The memory 1556 can include at least one of read-only memory (ROM), random access memory (RAM), a flash memory, a cache memory, an erasable programmable read-only memory (EPROM), an electrically erasable programmable read-only memory (EEPROM), a register, a hard disk drive (HDD), a solid-state drive (SSD), an optical disk drive, other memory, the like, or a combination thereof which is configured to store information (e.g., data, processor-readable instructions, software, a database, the like, or a combination thereof) and is configured to provide the information to the processor 1552.

The display 1558 (i.e. a user display device) can include a component configured to visually convey information to a user of the computing device 1550. In examples, the display 1558 can be a video display screen, such as a light-emitting diode (LED) screen, a touch screen, or both.

In examples, the display 1558 can display, such as via a user interface, information described herein, information produced by at least a portion of a method described herein, or both. In examples, the display 1558 can display a graphical user interface (GUI).

The user interface 1560 can include user devices such as a switch, a computer mouse, a trackpad, a keypad, a keyboard, a touch screen, a microphone, a speaker, an audio production device, a camera, a jack for coupling the computing device to an audio production device, the like, or a combination thereof. The user interface 1560 can optionally include a user interface controller. The user interface 1560 can include a component configured to convey information to a user of the computing device 1550, a component configured to receive information from the user of the computing device 1550, or both. In examples, the user interface 1560 can include the display 1558. In examples, the user interface 1560 can be configured to display at least a portion of information described hereby, such as information in a promissory file (i.e. a digital promissory file.

The fixed storage device 1562 can include one or more hard drive, flash storage device, the like, or a combination thereof. The fixed storage device 1562 can be an information storage device (e.g. storing a database) that is not configured to be removed during use. The fixed storage device 1562 can optionally include a fixed storage device controller. The fixed storage device 1562 can be integral with the computing device 1550 or can be separate and accessed through an interface.

The removable storage device 1564 can be integrated with the computing device 1550 or can be separated and accessed through other interfaces. The removable storage device 1564 can be an information storage device (e.g. storing a database) that is configured to be removed during use, such as a memory card, a jump drive, a flash storage device, an optical disk, the like, or a combination thereof. The removable storage device 1564 can optionally include a removable storage device controller. The removable storage device 1564 can be integrated with the computing device 1550 or can be separate and accessed through an interface.

In examples, a computer-readable storage medium such as one or more of the memory 1556, the fixed storage device 1562, the removable storage device 1564, a remote storage location, the like, or a combination thereof can store non-transitory computer-executable instructions configured to cause a processor (e.g. the processor 1552) to implement at least an aspect of the present disclosure.

The network interface 1566 can couple the processor 1552 (e.g. via the data bus 1554) to a network and enable exchanging information between the processor 1552 and the network. In some examples, the network interface 1566 can couple the processor 1552 (e.g. via the data bus 1554) to the network and enable exchanging information between the processor 1552 and another computing device. For example, the network interface 1566 can enable the processor 1552 to communicate with one or more other network devices. The network interface 1566 can couple to the network using any suitable technique and any suitable protocol. In some examples, the network interface 1566 can include a data bus, a power bus, a control signal bus, a status signal bus, the like, or a combination thereof. Example techniques and protocols the network interface 1566 can be configured to implement include digital cellular telephone, WiFi™, Bluetooth®, near-field communications (NFC), the like, or a combination thereof.

The network can couple the processor 1552 to one or more other network devices. In some examples, the network can enable exchange of information between the processor 1552 and the one or more other network devices. In some examples, the network can enable exchange of information between the processor 1552 and another computing device. The network can include one or more private networks, local networks, wide-area networks, the Internet, other communication networks, the like, or a combination thereof. In some examples, the network can be a wired network, a wireless network, an optical network, the like, or a combination thereof.

In some embodiments, the network device can store computer-readable instructions configured to cause a processor (e.g. the processor 1552) to initiate performing at least a portion of a method described hereby. In an example, the one or more other network devices can store non-transitory computer-executable instructions configured to cause a processor (e.g. the processor 1552) to implement at least an aspect of the present disclosure. The non-transitory computer-executable instructions can be received by the processor 1552 and implemented using at least a portion of techniques described hereby. In another example, information described hereby can be stored in the fixed storage device 1562, the removable storage device 1564, the network device, the like, or a combination thereof.

In some examples, the provided techniques can advantageously improve functioning of computing devices configured to perform at least a portion of a method described herein. For example, the provided techniques can advantageously improve processing techniques of computing devices configured to perform at least a portion of a method described herein. The provided techniques can advantageously improve functioning of computing devices configured to perform at least a portion of a method described herein and other technologies configured to perform at least a portion of a method described herein.

In examples, the term “notary” refers to a computing device configured to perform at least a portion of a notary service described hereby. In examples, the terms “transferee” and “transferor” can refer to respective computing devices configured to perform at least a portion of a process for transferring a digital promissory file, as described hereby. In examples, the terms “transferee” and “transferor” can refer to respective computing devices configured to perform at least a portion of a process for creating a digital promissory file, as described hereby.

In an exemplary embodiment, a method for constructing a cryptographically signable and verifiable binary promissory file issued by an authority comprises: a data structure for representing the semantic version number of the promissory file schema, a cryptographic signature system used, a universally unique identifier for a promissory file, an asset code, an amount, an authority cryptographic public key, an owner cryptographic public key, an issuance date timestamp, an authorized signature of the promissory file hash signed by the notary, a secured signature of the hash, signed by the previous owner public key or the authority public key for the first creation of the promissory file, a notary that authorizes each transfer, including the notary cryptographic public key and the signature of it from the asset authority, a list of asset provenance, comprised of identifiers of previous one or more promissory file(s), respective cryptographic hash(es) of previous one or more promissory file(s), and respective decimal amount(s) deducted from previous one or more promissory file(s) to add to the value of the current promissory file, a commitment group, linking the promissory file to transaction identifiers, and commitments identifiers between involved parties, and group names.

The above exemplary embodiment can further include reading the binary file, and returning the values stored therein.

The above exemplary embodiment can further include calculating and returning the next promissory file hash by creating a new hash digest of the current promissory file hash plus the cryptographic public key of the intended recipient to transfer the ownership of the promissory file.

The above exemplary embodiment can further include searching a local or remote file system directory for instances of promissory files and returning a list, array or vector of read file buffers.

The above exemplary embodiment can further include saving the file name for a promissory file instance based on the character string representation of the promissory asset code, decimal amount, and the universally unique identifier.

The above exemplary embodiment can further include creating, issuing or minting an instance of a promissory file provided configurable parameters for the semantic version number of the promissory file schema, a cryptographic signature system used, a universally unique identifier for a promissory file, an asset code, an amount, an authority cryptographic public key, an owner cryptographic public key, an issuance date timestamp, an authorized signature of the promissory file hash signed by the notary, a secured signature of the hash, signed by the previous owner public key or the authority public key for the first creation of the promissory file, a notary that authorizes each transfer, including the notary cryptographic public key and the signature of it from the asset authority, a list of asset provenance, comprised of identifiers of previous one or more promissory file(s), respective cryptographic hash(es) of previous one or more promissory file(s), and respective decimal amount(s) deducted from the previous one or more promissory file(s) to add to the value of the current promissory file, a commitment group, linking the promissory file to transaction identifiers, and commitments identifiers between involved parties, and group names.

The above exemplary embodiment can further include ordering or sorting based on the equalities of the decimal normalized amounts of comparison promissory files.

The above exemplary embodiment can further include normalizing a promissory file instance amount against promissory file instances with different decimal place precisions.

The above exemplary embodiment can further include calculating and returning the hash of the promissory file; and returning the immediate previous hash(es) of the immediate previous promissory file(s).

The above exemplary embodiment can further include retrieving the cryptographic public key of the latest promissory file, denoting the owner of the promissory file.

The above exemplary embodiment can further include: recursing the asset provenance list; and returning the immediate previous ancestor promissory files within the recursed list.

The above exemplary embodiment can further include providing the promissory file to the notary service which can recurse the asset provenance list; and returning the entire history of ancestor promissory files of the promissory file with validations of amounts being calculated correctly.

The above exemplary embodiment can further include: assigning or transferring ownership of the promissory file provided a recipient's cryptographic public key to calculate the next promissory file hash and cryptographically sign the hash with the current promissory file owner's cryptographic signing key, supplying the cryptographic signature along with the recipient's cryptographic public address and optional cryptographic signature of the calculated next promissory file hash from the notary to be used in the cryptographic verification and construction of the next promissory file hash; updating the state of the promissory file; and returning the latest promissory data with the updated asset provenance list.

The above exemplary embodiment can further include: verifying the cryptographic correctness of the promissory file solely from the contents of the promissory file, computing the previous immediate ancestor promissory file hash, recursing the asset provenance list and verifying the authorized and secured cryptographic signatures for the previous immediate ancestor promissory file hash(es) matches the re-computed asset provenance ; providing the ability to locally verify correctness of the promissory file without reliance on network connectivity.

The above exemplary embodiment can further include receiving an asynchronous cryptographic signature from the notary of the promissory file that is either (i) the signature for the current promissory file hash or, (ii) the signature for pre-authorizing the next computed promissory file hash based on a recipient's cryptographic public key; and updating the promissory file's authorized signature.

The above exemplary embodiment can further include organizing promissory files for a given cryptographic public key in a binary heap to sort from highest to lowest decimal normalized promissory file amounts; and calculating the exact or nearest balance to a parameterized currency amount from a sorted collection, array, vector, tree or mapped data structure of promissory files.

The above exemplary embodiment can further include creating three promissory files on a transfer when exact asset amounts are not available by the sender and ‘change’is required.

The promissory file representing the ‘change’ can be returned immediately by the notary to avoid having the entire promissory file amount locked up while the transfer is being processed, unlike various other Unspent Transaction Output (UTXO) based systems out in the market which is locked throughout the entire transaction lifecycle. The promissory file representing the amount to be sent to the new owner is created in the case of a successful transfer and the promissory file representing the amount to be sent back to the sender is created in the case a ‘refund’ scenario. Upon a successful scenario, the ‘refund’ promissory file is kept by the notary, and the ‘transfer’ promissory file is sent to the recipient. Upon a refund scenario, the ‘transfer’ promissory file is kept by the notary, and the ‘refund’promissory is returned to the sender.

The above exemplary embodiment can further include sending multiple promissory files in a transaction and having the multiple promissory files combined into one promissory file to the recipient, sending one promissory file back to the sender if a ‘refund’ is required, and sending one promissory file back to the sender when ‘change’is required to be sent to the sender.

In an exemplary embodiment, a system for issuing promissory files, comprises: processing of computer instructions configured to receive, from a remote computing device using an Internet Protocol (IP) address, instructions for issuing a batch of promissory files given a cryptographic signing key; requesting from an authority, specified at an Internet Protocol (IP) address, a max limit on the face-value amount of promissory files allowed to be issued by and signed for a cryptographic signing and verifying key; receiving back from an authority the current amounts issued by a cryptographic signing key by providing a cryptographic public key; sending a batch of promissory files to an authority, specified at an Internet Protocol (IP) address, to verify and approve the issuance of the promissory files; receiving back a batch of promissory files from an authority with an authorized cryptographic signature from the authority stored within each of the promissory files of the batch; transferring to an authority a batch of promissory files to be destroyed by the authority; transferring to a remote device, using an agnostic Open Systems Interconnection (OSI) model L4 transport layer, issued and authorized promissory files; configuring administrative access to the system based on cryptographic key pairs associated with role based access control (RBAC) rules; receiving from a remote device, using an Internet Protocol (IP) address, a request for cryptographic signing of a batch of promissory files and returning the promissory files to the remote device with an updated authorized signature for each of the promissory files; and returning paginated results for the promissory files issued by a cryptographic signing key, referenced by a cryptographic public key.

In an exemplary embodiment, a system for authorizing promissory files, comprises: processing of computer instructions configured to receive, from a remote computing device using an Internet Protocol (IP) address, a batch of issued promissory files to be authorized by a cryptographic signing key; verifying the cryptographic public key of the issuer for each of the promissory files in a batch; indexing the current ownership of a promissory file associated with a cryptographic public key in persistent storage readable and writable by the system; recording the current total and max limit face-value amount of promissory files issued by a cryptographic signing key, referenced by a cryptographic public key in persistent storage readable and writable by the system; receiving from a remote device, using an Internet Protocol (IP) address, a request for cryptographic signing of a batch of promissory files and returning the batch of promissory files to the remote device with an updated authorized signature for each of the promissory files within the batch; configuring administrative access to the system based on cryptographic key pairs associated with role based access control (RBAC) rules; returning paginated results for the cryptographic public keys authorized by an authority and granted to be promissory file issuers; and searching financial sanction lists to approve or deny the authorization of a promissory file for a cryptographic public key.

In an exemplary embodiment, a system for exchanging foreign denominated promissory files, comprises: processing of computer instructions configured to receive, from a remote computing device using an Internet Protocol (IP) address, a batch of promissory files denominated in one currency or asset type to be exchanged for a batch of promissory files of equivalent value denominated in another currency or asset type; configuring administrative access to the system based on cryptographic key pairs associated with role based access control (RBAC) rules; recording a log of promissory files exchanged in persistent storage readable and writable by the system; returning a forward and spot market exchange rate between currency and asset pairs; and maintaining an order book of promissory files to be exchanged.

In an exemplary embodiment, a system for remitting promissory files, comprises: processing of computer instructions configured to receive, from a remote computing device using an Internet Protocol (IP) address, a batch of promissory files to be converted into a desired amount to be remitted in a desired currency or asset to a forwarded or receiving cryptographic public key, received by a remote device at an Internet Protocol (IP) address; and returning of promissory files back to the original sender in a residual or remainder amount net of the face-value of promissory files to be remitted.

In an exemplary embodiment, a system for screening the illicit transfer of promissory files comprises processing of computer instructions configured to maintain an encrypted and private record of cryptographic public keys associated with personal identifiable information (PII); monitoring of promissory file transactions from cryptographic public keys; and reporting suspicious activities from cryptographic public keys to authorities.

In an exemplary embodiment, a system for maintaining custodianship of promissory files, comprises: processing of computer instructions configured to maintain encrypted storage of promissory files owned by a cryptographic public key; receiving promissory files from a remote device for the encryption and persistent storage of the promissory files; and decrypting and sending promissory files to the owner of the promissory file denoted by the cryptographic public key in the latest signature block using an Internet Protocol (IP) address to a remote device.

In an exemplary embodiment, provided is a system where two parties can exchange promissory files of designated values and a notary can ensure both transfers complete or neither completes, thus implementing reliable payment-vs-payment or delivery-vs-payment without the risk of one party to the exchange.

Exemplary embodiments discussed herein can provide certain advantages. These advantages can include those provided by the disclosed features.

Although methods and apparatus are described hereby in a language specific to structural features and/or methods, the appended claims are not necessarily limited to the specific features or methods described. Rather, the specific features and methods are disclosed as examples of implementations.

One or more embodiments of the disclosed subject matter are described herein with specificity to meet statutory requirements, but this description does not limit the scope of the claims. The claimed subject matter can be embodied in other ways, can include different elements or steps, and can be used in conjunction with other existing or later developed technologies. This description should not be interpreted as implying any required order or arrangement among or between various steps or elements except when the order of individual steps or arrangement of elements is explicitly noted as being required.

Embodiments of the disclosure are described more fully herein with reference to the accompanying drawings, which form a part hereof, and which show, by way of illustration, exemplary embodiments by which the disclosure can be practiced. The disclosure may, however, be embodied in different forms and should not be construed as limited to the embodiments set forth herein, rather, these embodiments are provided so that this disclosure will satisfy the statutory requirements and convey the scope of the disclosure to those skilled in the art.

Among others, the subject matter of the disclosure can be embodied in whole or in part as a system, as one or more methods, or as one or more devices. Embodiments can take the form of a hardware implemented embodiment, a software implemented embodiment, or an embodiment combining software and hardware aspects. For example, in some embodiments, one or more of the operations, functions, processes, or methods disclosed and/or described herein can be implemented by one or more suitable processing elements (such as a processor, co-processor, microprocessor, Central Processing Unit, Graphics Processing Unit, Tensor Processing Unit, Quantum Processing Unit, controller, or a combination thereof, as non-limiting examples) that is part of a client device, server, network element, remote platform (such as a Software as a Service (Saas) platform), an “in the cloud” service, or other form of computing or data processing system, device, or platform.

The processing element or elements can be programmed with a set of executable instructions (e.g. software instructions), where the instructions can be stored on (or in) one or more suitable non-transitory computer-readable data storage elements, one or more suitable non-transitory computer-readable media, or both. In an embodiment, the set of instructions can be conveyed to a user through a transfer of instructions or an application that executes a set of instructions (such as over a network, e.g., the Internet). In an embodiment, a set of instructions or an application can be utilized by an end-user through access to a SaaS platform or a service provided through such a platform.

In an embodiment, the methods and apparatus disclosed herein can provide services through a SaaS or multi-tenant platform. The platform provides access to multiple entities, each with a separate account and associated data storage. Each account can correspond to a User, set of Users, an entity, a set or category of entities, a company, a business advisor, a set or category of Users, an industry, an organization, or a combination thereof, as examples. Each account can access one or more services, a set of which are instantiated in their account, and which implement at least a portion of one or more of the methods, features, or functions disclosed herein.

In an embodiment, one or more of the operations, functions, processes, features, or methods disclosed herein can be implemented by a specialized form of hardware, such as a programmable gate array, application specific integrated circuit (ASIC), or the like. An embodiment of the disclosure can be implemented in the form of an application, a sub-routine that is part of a larger application, a “plug-in,” an extension to the functionality of a data processing system or platform, or other suitable form. This description is, therefore, not to be taken in a limiting sense.

It should be understood that the examples of the methods and apparatus described herein can be implemented in a form of control logic using computer software in a modular or integrated manner. Based on the disclosure and teachings provided herein, a person of ordinary skill in the art will know and appreciate other techniques to implement an embodiment of the disclosure using hardware or a combination of hardware and software.

Any of the software components, processes or functions described in this application can be implemented as software code to be executed by a processor using any suitable computer language such as at least one of Python, Java, Javascript, C, C++, C #(“C Sharp”), Type Script, Java Script, Platform Client Application Programming Interface (API) Script, or Perl using procedural, functional, object-oriented, or other techniques. The software code can be stored as a series of instructions, or commands in (or on) a non-transitory computer-readable medium, such as a random-access memory (RAM), a read only memory (ROM), a magnetic medium such as a hard-drive, a jump drive, an optical medium such as a CD-ROM, or a combination thereof. In this context, a non-transitory computer-readable medium is almost any medium suitable for the storage of data or an instruction set aside from a transitory waveform. Any such computer readable medium can reside on or within a single computational apparatus and can be present on or within different computational apparatuses within a system or network.

According to one example implementation, the term processing element or processor, as used herein, can be a central processing unit (CPU), or conceptualized as a CPU (such as a virtual machine). In this example implementation, the CPU or a device in which the CPU is incorporated can be at least one of coupled, connected, or in communication with one or more peripheral devices, such as the user display device. In another example implementation, the processing element or processor can be incorporated into a mobile computing device, such as a smartphone or tablet computer.

The non-transitory computer-readable storage medium referred to herein can include a number of physical drive units, such as a redundant array of independent disks (RAID), a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer-readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium can include almost any structure, technology, or method apart from a transitory waveform or similar medium.

Certain implementations of the disclosed technology are described herein with reference to block diagrams of systems, and/or to flowcharts or flow diagrams of functions, operations, processes, or methods. It will be understood that one or more blocks of the block diagrams, or one or more stages or steps of the flowcharts or flow diagrams, and combinations of blocks in the block diagrams and stages or steps of the flowcharts or flow diagrams, respectively, can be implemented by computer-executable program instructions. In some embodiments, one or more of the blocks, or stages or steps may not necessarily need to be performed in the order presented or may not necessarily need to be performed.

The computer-executable program instructions described herein can be loaded onto a special purpose computer, a processor, or other programmable data processing apparatus to produce a specific example of a machine, such that the instructions executed by the computer, processor, or other programmable data processing apparatus create means for implementing one or more of the functions, operations, processes, or methods described herein. These computer program instructions can also be stored in a computer-readable memory that can direct a computer or other programmable data processing apparatus to function in a specific manner, such that the instructions stored in the computer-readable memory produce an article of manufacture including instruction means that implement one or more of the functions, operations, processes, or methods described herein.

While certain implementations of the disclosed technology have been described in connection with what is presently considered to be the most practical and various implementations, it is to be understood that the disclosed technology is not to be limited to the disclosed implementations. Instead, the disclosed implementations are intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, and to enable any person skilled in the art to practice certain implementations of the disclosed technology, including making and using any devices or systems and performing any incorporated methods. The patentable scope of certain implementations of the disclosed technology is defined in the claims, and can include other examples that occur to those skilled in the art. Such other examples are intended to be within the scope of the claims when they have structural elements, functional elements, or both that do not differ from the literal language of the claims, or if they include structural elements, functional elements, or both with insubstantial differences from the literal language of the claims.

The use of the terms “a,” “an,” “the,” and similar referents in the specification and in the following claims are to be construed to cover both the singular and the plural, unless otherwise indicated herein or clearly contradicted by context. The singular portends the plural, where practicable. The terms “having,” “including,” “containing,” and similar referents in the specification and in the claims are to be construed as open-ended terms (e.g. meaning “including, but not limited to,”) unless otherwise noted. All methods described herein can be performed in any suitable order unless otherwise indicated herein or clearly contradicted by context. The use of all examples, or exemplary language (e.g. “such as”) provided herein, is intended merely to better illuminate embodiments of the disclosure and do not pose a limitation to the scope of the disclosed methods and apparatus unless otherwise claimed. No language in the specification should be construed as indicating any non-claimed element as essential to each embodiment of the disclosed methods and apparatus.

The words “receiving,” “generating,” “extracting,” “determining,” “calculating,” and other forms thereof are intended to be open ended in that an item or items following any one of these words is not meant to be an exhaustive listing of such item or items or meant to be limited to only the listed item or items. The term “or” is used inclusively to refer to items in the alternative and in combination.

Different arrangements of the components depicted in the drawings or described above, as well as components and steps not shown or described are possible. Similarly, some features and sub-combinations are useful and can be employed without reference to other features and sub-combinations. Embodiments of the disclosed methods and apparatus have been described for illustrative and not restrictive purposes, and alternative embodiments will become apparent to readers of this patent. Accordingly, the disclosed methods and apparatus are not limited to the embodiments described herein or depicted in the drawings, and various embodiments and modifications can be made without departing from the scope of the claims. The disclosed embodiments are merely exemplary of the disclosure, which can be embodied in various forms.

What is claimed is:

1. A computer-implemented method for constructing a new promissory file that is cryptographically signable, verifiable, and represents an asset issued by an asset authority, comprising:
creating, using the computing device, the new promissory file, wherein the new promissory file comprises information describing:
a universally unique identifier;
a version number;
a cryptographic signature system;
a decimal amount;
an asset code;
a cryptographic public key matching a cryptographic signing key;
a cryptographic public key of the asset owner;
a cryptographic public key of the asset authority;
a promissory file issuance date timestamp that is generated by an operating system;
a cryptographic signature by the notary of a latest promissory file hash;
a cryptographic signature by the previous promissory file owner of a latest promissory file hash;
a notary that authorizes a transfer, including information describing the notary cryptographic public key and a signature of the notary cryptographic public key from the asset authority;
a list of asset provenance, comprising an identifier of a previous promissory file, a respective cryptographic hash of the previous promissory file, and a respective decimal amount deducted from a previous promissory file to add to the value of the new promissory file; and
a commitment group configured to link the new promissory file to the transaction identifier, commitment identifiers between involved parties, and a group name;
creating, using the computing device and based on information stored in the new promissory note, an initial hash of the new promissory file, wherein the initial hash is signed by the cryptographic signing key of the asset authority and the notary;
storing, using the computing device, the initial hash in the new promissory file in a file system; and
storing, using the computing device, the new promissory file in a file system.

2. The computer-implemented method of claim 1, further comprising:
reading, using the computing device, the new promissory file; and
returning values stored in the new promissory file.

3. The computer-implemented method of claim 1, further comprising:
calculating, using the computing device, a next promissory file hash by creating a new hash digest of the new promissory file and a cryptographic public key of an intended recipient to transfer ownership of the new promissory file to the intended recipient; and
cryptographically signing the new promissory file by:
the asset authority after the new promissory file is created and prior to an initial transfer of ownership; or
a previous owner of the new promissory file when the new promissory file is subsequently transferred; and
cryptographically signing the new promissory file by the notary of the new hash digest.

4. The computer-implemented method of claim 1, further comprising:
searching, using the computing device, a file system directory for instances of previous promissory files to create a list of previous promissory files; and
returning, from read file buffers, information in the list of previous promissory files.

5. The computer-implemented method of claim 1, further comprising saving, in the file system, a file name for a promissory file instance based on:
a character string representation of the asset code;
the decimal amount; and
the universally unique identifier.

6. The computer-implemented method of claim 1, further comprising issuing, using the computing device, the new promissory file.

7. The computer-implemented method of claim 1, further comprising ordering, using the computing device, comparison promissory files, wherein the ordering is based on decimal normalized amounts of the comparison promissory files.

8. The computer-implemented method of claim 1, further comprising normalizing, using the computing device, a promissory file instance amount against promissory files having different decimal place precisions.

9. The computer-implemented method of claim 1, further comprising:
calculating, using the computing device, an immediate previous hash of an immediate previous promissory file; and
returning the immediate previous hash of the immediate previous promissory file.

10. The computer-implemented method of claim 1, further comprising retrieving, from the file system, latest ownership details of the new promissory file.

11. The computer-implemented method of claim 1, further comprising retrieving, from the file system:
an identifier of the immediate previous promissory file;
an asset value of the immediate previous promissory file;
a hash of the immediate previous promissory file; or
a combination thereof.

12. The computer-implemented method of claim 1, further comprising:
receiving a cryptographic public key of a recipient;
assigning, using the computing device, ownership of the new promissory file by:
using a cryptographic public key of the recipient to calculate a next promissory file hash; and
cryptographically signing the next promissory file hash with a cryptographic signing key of a current promissory file owner;
supplying, using the computing device, a cryptographic signature and a cryptographic public address of the recipient for use in a cryptographic verification and construction of a next promissory file hash;
updating, using the computing device, a state of the new promissory file; and
returning latest promissory data in the new promissory file.

13. The computer-implemented method of claim 12, further comprising supplying, using the computing device, a cryptographic signature from a notary of a calculated next promissory file hash for use in cryptographic verification and construction of a next promissory file hash.

14. The computer-implemented method of claim 12, further comprising:
maintaining network connectivity to the notary, wherein the notary retains a copy of previous promissory files; and
communicating, with the notary, as a portion of a transfer of the new promissory file, only the immediate previous promissory file identifier, the initial hash, and the respective decimal amount deducted from a previous promissory file to add to the value of the new promissory file.

15. The computer-implemented method of claim 12, wherein a plurality of parties are exchanging digital promissory files, and further comprising ensuring, by the notary, that either all transfers of the digital promissory files in the exchange complete or none of the transfers of the digital promissory files in the exchange complete.

16. The computer-implemented method of claim 1, further comprising:
verifying, using the computing device, a cryptographic correctness of the promissory file solely from information stored in the promissory file;
computing, using the computing device, a provenance promissory file hash;
recursing, using the computing device, a list of asset provenance files;
verifying, using the computing device, notary and previous owner cryptographic signatures for a latest promissory file hash and from a list of provenance promissory files; and
verifying correctness of the promissory file without reliance on network connectivity.

17. The computer-implemented method of claim 1, further comprising:
receiving, using the computing device and from the asset authority, an asynchronous cryptographic signature of the promissory file that is:
a signature for a current promissory file hash or;
a signature for pre-authorizing a next computed promissory file hash based on a cryptographic public key of a recipient; and
updating, using the computing device, an authorized signature of the promissory file.

18. The computer-implemented method of claim 1, further comprising:
organizing, using the computing device, a plurality of promissory files for a given cryptographic public key in a binary heap to sort from highest to lowest respective decimal normalized promissory file amounts; and
calculating, using the computing device, a nearest balance of an account to a parameterized asset amount from a sorted collection.

19. A system configured to automatically construct a new promissory file that is cryptographically signable, verifiable, and represents an asset issued by an asset authority, comprising:
an electronic processor configured to execute a set of computer-executable instructions; and
a memory communicatively coupled to the electronic processor and storing the set of computer-executable instructions, wherein the set of computer-executable instructions are configured to cause the electronic processor to:
create the new promissory file, wherein the new promissory file comprises information describing:
a universally unique identifier;
a version number;
a cryptographic signature system;
a decimal amount;
an asset code;
a cryptographic public key matching a cryptographic signing key;
a cryptographic public key of the asset owner;
a cryptographic public key of the asset authority;
a promissory file issuance date timestamp that is generated by an operating system;
a cryptographic signature by the notary of a latest promissory file hash;
a cryptographic signature by the previous promissory file owner of a latest promissory file hash;
a notary that authorizes a transfer, including information describing the notary cryptographic public key and a signature of the notary cryptographic public key from the asset authority;
a list of asset provenance, comprising an identifier of a previous promissory file, a respective cryptographic hash of the previous promissory file, and a respective decimal amount deducted from a previous promissory file to add to the value of the new promissory file; and
a commitment group configured to link the new promissory file to the transaction identifier, commitment identifiers between involved parties, and a group name;
create, based on information stored in the new promissory note, an initial hash of the new promissory file, wherein the initial hash is signed by the cryptographic signing key of the asset authority and the notary;
store the initial hash in the new promissory file; and
store the new promissory file in a file system.

20. A non-transitory computer-readable medium, comprising processor-executable instructions stored thereon configured to cause a processor to:
create a new promissory file, wherein the new promissory file comprises information describing:
a universally unique identifier;
a version number;
a cryptographic signature system;
a decimal amount;
an asset code;
a cryptographic public key matching a cryptographic signing key;
a cryptographic public key of the asset owner;
a cryptographic public key of the asset authority;
a promissory file issuance date timestamp that is generated by an operating system;
a cryptographic signature by the notary of a latest promissory file hash;
a cryptographic signature by the previous promissory file owner of a latest promissory file hash;
a notary that authorizes a transfer, including information describing the notary cryptographic public key and a signature of the notary cryptographic public key from the asset authority;
a list of asset provenance, comprising an identifier of a previous promissory file, a respective cryptographic hash of the previous promissory file, and a respective decimal amount deducted from a previous promissory file to add to the value of the new promissory file; and
a commitment group configured to link the new promissory file to the transaction identifier, commitment identifiers between involved parties, and a group name;
create, based on information stored in the new promissory note, an initial hash of the new promissory file, wherein the initial hash is signed by the cryptographic signing key of the asset authority and the notary;
store the initial hash in the new promissory file; and
store the new promissory file in a file system.
